(19) United States
(12) Patent Application Publication
(10) Pub. No.: US 2026/0170312 A1
(43) Pub. Date: Jun. 18, 2026

(54) REAL-TIME AI WITNESS EXAMINATION ASSISTANT

(71) Applicant: FullProof Systems Inc., Campbell, CA (US)

(72) Inventors: Neda Mansoorian, Campbell, CA (US); Patrick Wetherbee, San Francisco, CA (US)

(21) Appl. No.: 19/421,312

(22) Filed: Dec. 16, 2025

Related U.S. Application Data
(60) Provisional application No. 63/735,647, filed on Dec. 18, 2024.

(51) Int. Cl. G06N 3/0475; G10L 15/02; G10L 15/18

(52) U.S. Cl. CPC G06N 3/0475; G10L 15/02; G10L 15/1815

(57) ABSTRACT

Systems, methods, and computer-readable media for assisting a user in a witness examination proceeding. A system may include one or more microphones operable to receive audio data of a witness, one or more cameras operable to receive video data of the witness, a user input device operable to receive user input data, a data store for storing case file data, a processor, and one or more non-transitory computer-readable media comprising computer-executable instructions that, when executed by the processor, perform a method for assisting with a witness examination proceeding. The method may include storing, via the data store, the case file data; providing, to a large language model and in real time during the witness examination proceeding, the audio data and the case file data; receiving, from the large language model and in response, a suggestion for a user; and displaying to the user, via a witness examination dashboard, the suggestion.

### CROSS-REFERENCE TO RELATED APPLICATIONS

This patent application is a non-provisional application claiming priority benefit, with regard to all common subject matter, of U.S. Provisional Patent Application No. 63/735,647, filed Dec. 18, 2024, and entitled “REAL-TIME AI DEPOSITION ASSISTANT.” The above-referenced application is hereby incorporated by reference in its entirety into the present application.

### BACKGROUND

### 1. Field

Embodiments of the present disclosure relate to artificial intelligence agents for real-time proceedings. More specifically, embodiments of the present disclosure relate to artificial intelligence systems adapted for witness examination proceedings.

### 2. Related Art

Witness examinations—including depositions, interviews, arbitration examinations, trial examinations, administrative hearings, informal witness examinations, and other examination proceedings—are critical components of litigation and dispute resolution, often determining the outcome of cases because of an attorney's ability to derive authentic and credible evidence directly from witnesses. However, carrying out an effective witness examination proceeding comes with challenges for the attorney due to the limitations of human cognitive capacity. During a witness examination, attorneys must simultaneously manage an overwhelming number of tasks, such as actively listening to the witness, formulating immediate follow-up questions based on the witness's answers, adhering to a prepared outline of key questions, and recalling critical case details, including thousands (sometimes millions) of documents, applicable laws, and case theories relevant to the witness examination at hand. This cognitive juggling, compounded by distractions like objections from opposing counsel, interruptions from court reporters, and input from clients or team members, places immense pressure on the attorney across all witness examination settings, leading to serious mistakes and oversights. The human brain, despite its capabilities, cannot maintain the precision and stamina required to conduct a focused and effective witness examination that may extend for many hours.

The high stakes further amplify the issue, as witness examinations are not just routine tasks but pivotal moments where a single missed question or overlooked answer could significantly impact the case outcome, including extending costly, uncertain, and stressful litigation by months and even years. With clients often paying a large sum of money for a witness examination proceeding, the expectations on attorneys are immense. Despite extensive preparation, even experienced attorneys frequently recognize, in hindsight, missed opportunities to extract crucial testimony, reference prior documents and testimony, or clarify evasive answers from a witness. The cognitive gymnastics required during real-time witness examination proceedings cannot be performed by the human mind and exceed the natural limitations of human cognitive agility and mental capacity. As a result, attorneys face the task of performing at peak mental acuity while navigating complex, fast-moving, and high-pressure scenarios. A tool is needed to assist attorneys in managing the overwhelming number of tasks and distractions that witness examination proceedings, such as depositions, currently entail so that they can carry out effective and efficient witness examinations for their clients.

### SUMMARY

Embodiments of the present disclosure solve the above-mentioned problems by providing a witness examination assistant system for assisting a user (e.g., an examining attorney) with a witness examination proceeding.

In some embodiments, the techniques described herein relate to a witness examination assistant system, including: one or more microphones operable to receive audio data of a witness; one or more cameras operable to receive video data of the witness; a user input device operable to receive user input data including chat data; a data store for storing case file data; at least one processor; and one or more non-transitory computer-readable media including computer-executable instructions that, when executed by the at least one processor, perform a method for assisting with a witness examination proceeding, the method including: storing, via the data store, the case file data; providing, to a large language model and in real time during the witness examination proceeding, the audio data and the case file data; receiving, from the large language model and in response, a suggestion for a user; and causing display of, to the user and via a witness examination dashboard displayed on a user device, the suggestion for the user.

In some embodiments, the techniques described herein relate to a witness examination assistant system, wherein the method further includes determining tone and sentiment data based at least on the video data or the audio data.

In some embodiments, the techniques described herein relate to a witness examination assistant system, wherein the suggestion is further based on the tone and sentiment data.

In some embodiments, the techniques described herein relate to a witness examination assistant system, wherein the case file data includes a witness examination outline, such as a deposition outline or a trial or arbitration cross-examination outline wherein the suggestion includes modifying in real time the witness examination outline.

In some embodiments, the techniques described herein relate to a witness examination assistant system, wherein processing of the audio data and the case file data by the large language model reveals an inconsistency between testimony of the witness and the case file data, wherein the suggestion includes a question to ask the witness regarding the inconsistency.

In some embodiments, the techniques described herein relate to a witness examination assistant system, wherein the chat data is provided as an input to the large language model, wherein the suggestion is further based on the chat data.

In some embodiments, the techniques described herein relate to a witness examination assistant system, wherein the suggestion includes updating a timeline displayed on the witness examination dashboard.

In some embodiments, the techniques described herein relate to a witness examination assistant system, wherein the large language model runs on a remote cloud server.

In some embodiments, the techniques described herein relate to a witness examination assistant system, wherein the large language model is trained at least on the case file data.

In some embodiments, the techniques described herein relate to a witness examination assistant system, wherein the audio data is provided to the large language model as a real-time transcript.

In some embodiments, the techniques described herein relate to a witness examination assistant system, wherein processing of the audio data and the case file data by the large language model detects an instance of a particular speaker, wherein the suggestion is further based on the instance of the particular speaker.

In some embodiments, the techniques described herein relate to a method for assisting with a witness examination proceeding, the method including: storing, via a data store, case file data; receiving, via one or more microphones, audio data of a witness; providing, to a large language model and in real time during the witness examination proceeding, the audio data and the case file data; receiving, from the large language model and in response, a suggestion for a user; and causing display of, to the user and via a witness examination dashboard displayed on a user device, the suggestion for the user.

In some embodiments, the techniques described herein relate to a method, further including: receiving, via a user input device, chat data; and providing, to the large language model and in real time during the witness examination proceeding, the chat data, wherein the suggestion is based at least in part on the chat data.

In some embodiments, the techniques described herein relate to a method, further including; generating an attorney performance evaluation based on a performance of the user during the witness examination proceeding or a mock practice and preparation run-through and simulation; and causing display of, to the user and via the witness examination dashboard, the attorney performance evaluation.

In some embodiments, the techniques described herein relate to a method, further including: generating a witness score based on a reliability of the witness during the witness examination proceeding; and causing display of, to the user and via the witness examination dashboard, the witness score.

In some embodiments, the techniques described herein relate to one or more non-transitory computer-readable media storing computer-executable instructions that, when executed by at least one processor, perform a method for assisting with a witness examination proceeding, the method including: storing, via a data store, case file data; providing, to a large language model and in real time during the witness examination proceeding, audio data of a witness, chat data, and the case file data; receiving, from the large language model and in response, a suggestion for a user; and causing display of, to the user and via a witness examination dashboard displayed on a user device, the suggestion for the user.

In some embodiments, the techniques described herein relate to one or more non-transitory computer-readable media, wherein providing the audio data to the large language model includes providing a real-time transcript generated from the audio data.

In some embodiments, the techniques described herein relate to one or more non-transitory computer-readable media, further including; generating a witness examination outline based on the case file data; and causing display of, to the user and via the witness examination dashboard, the witness examination outline.

In some embodiments, the techniques described herein relate to one or more non-transitory computer-readable media, wherein the suggestion includes updating, based on the real-time transcript, the witness examination outline displayed on the witness examination dashboard, wherein updating the witness examination outline includes: updating a progress indicator associated with an item contained within the witness examination outline.

In some embodiments, the techniques described herein relate to one or more non-transitory computer-readable media, further including: detecting, within the real-time transcript, a predetermined name; and retrieving, upon detecting the predetermined name, contextual information associated with the predetermined name via one or more external data sources, wherein the suggestion is based at least in part on the contextual information.

This summary is provided to introduce a selection of concepts in a simplified form that are further described below in the detailed description. This summary is not intended to identify key features or essential features of the claimed subject matter, nor is it intended to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 illustrates an exemplary hardware platform in accordance with embodiments of the invention.

FIG. 2 depicts an exemplary witness examination assistant system for assisting a user with a witness examination in accordance with embodiments of the invention.

FIG. 3 depicts an exemplary witness examination assistant system for assisting a user with a witness examination in accordance with embodiments of the invention.

FIG. 4 depicts an exemplary user interface of an examination dashboard in accordance with embodiments of the invention.

FIG. 5 depicts an exemplary method for assisting with a witness examination proceeding in accordance with embodiments of the invention.

The drawing figures do not limit the present disclosure to the specific embodiments disclosed and described herein. The drawings are not necessarily to scale; emphasis is instead placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

The following disclosure is directed to systems, methods, and computer-readable media for providing one or more prompts to solve the problem of a human's limited capacity to manage, in real-time, the overwhelming number of tasks and distractions that witness examination entail. For example, the following disclosure includes a witness examination assistant system configured to generate one or more prompts (e.g., updating a live transcript, detecting speakers, detecting inconsistencies, updating a witness examination outline, making a suggestion, updating a timeline, summarizing aspects of a witness examination, or analyzing a witness' tone and sentiment) that assist an attorney's limited human capacity in managing a witness examination.

Embodiments of this disclosure include a system, which may include one or more microphones, one or more cameras, a user input device, or a data store operable to receive and/or provide input data such as audio, video, user input, or case file data. The system may further include a witness examination agent (e.g., deposition agent), which may be assisted by sub-agents, configured to process the input data. Based on the processing of the input data, the witness examination agent is configured to generate a prompt for the user. The prompt may be displayed on a client device to assist the user with carrying out the witness examination. The witness examination agent may generate the prompt based on processing the input data, such as the audio, video, user input, and case file data. The witness examination agent may use a large language model (LLM) to process the input data to generate the prompt. The prompt may include any output or modification to user interface elements displayed on a dashboard of a client device for assisting a user with a witness examination in real-time. For example, a prompt may include updating a real-time transcript based on the audio data. In another example, the prompt may include a question to ask a witness regarding an inconsistent statement made by the witness. In even a further example, the prompt may include updating a timeline displayed on the dashboard of the client device.

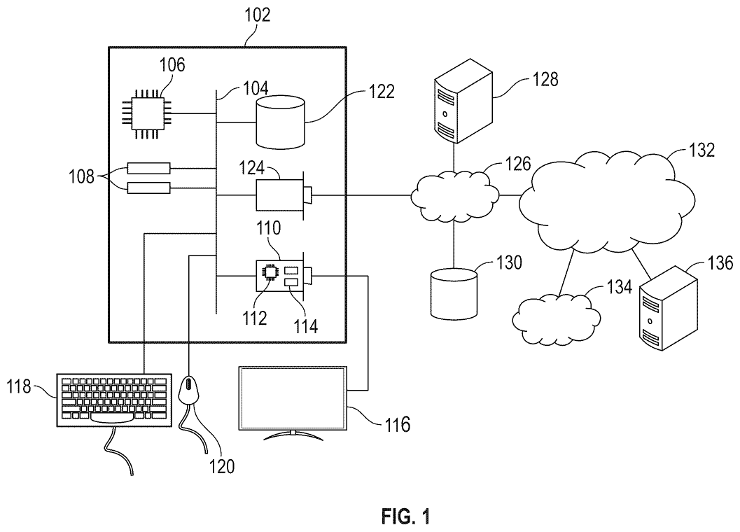

FIG. 1 illustrates an exemplary hardware platform in accordance with embodiments of the invention. Computer 102 can be a desktop computer, a laptop computer, a server computer, a mobile device such as a smartphone or tablet, or any other form factor of general or special-purpose computing device. Depicted with computer 102 are several components for illustrative purposes. In some embodiments, certain components may be arranged differently or absent. Additional components may also be present. Included in computer 102 is system bus 104, whereby other components of computer 102 can communicate with each other. In certain embodiments, there may be multiple buses, or components may communicate with each other directly. Connected to system bus 104 is central processing unit 106, also known as a CPU. Also attached to system bus 104 are one or more random-access memory (RAM) modules 108. Also attached to system bus 104 is graphics card 110. In some embodiments, graphics card 110 may not be a physically separate card but may be integrated into the motherboard or the central processing unit 106. In some embodiments, graphics card 110 has a separate graphics-processing unit (GPU) 112, which can be used for graphics processing or general-purpose computing (GPGPU). Also on graphics card 110 is GPU memory 114. Connected (directly or indirectly) to graphics card 110 is display 116 for user interaction. In some embodiments, no display is present, while in others, it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media and may be internally installed in computer 102 or externally and removably attached.

Such non-transitory computer-readable media include both volatile and nonvolatile media, removable and nonremovable media, and contemplate media readable by a database. For example, non-transitory computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical but transitory forms of signal transmission such as radio broadcasts, electrical signals through a wire, or light pulses through a fiber-optic cable. Examples of stored information include computer-executable instructions (for example, non-transitory computer-executable instructions that, when executed by a processor, perform the methods disclosed herein), data structures, program modules, and other data representations.

Finally, network interface card 124 (also known as a NIC) is attached to system bus 104 and allows computer 102 to communicate over a network such as local network 126. Network interface card 124 can be any form of network interface known in the art, such as Ethernet, ATM, fiber, Bluetooth®, or Wi-Fi (i.e., the IEEE 802.11 family of standards). Network interface card 124 connects computer 102 to local network 126, which may include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API that provides only read, write, and seek operations, or any level of complexity in between. Some data stores may additionally provide management functions for data sets stored therein, such as backup or versioning. Data stores can be local to a single computer, such as computer 128, accessible on a local network, such as local network 126, or remotely accessible over Internet 132. Local network 126 is, in turn, connected to Internet 132, which connects many networks such as local network 126, remote network 134, or directly attached computers such as computer 136. In some embodiments, computer 102 can itself be directly connected to Internet 132.

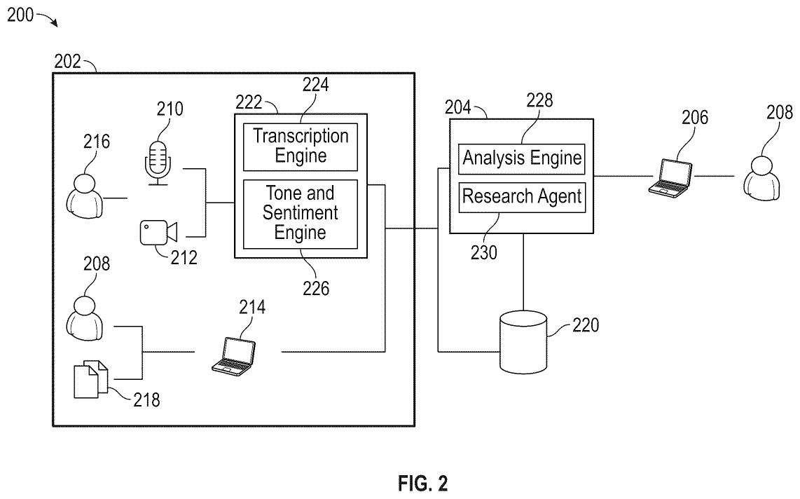

FIG. 2 depicts an exemplary witness examination assistant system for assisting a user with a witness examination in accordance with embodiments of the invention generally referred to as system 200. Broadly, system 200 includes a witness examination agent for generating one or more prompts or suggestions for assisting a user with a witness examination in real-time. The prompts may be based on the processing of input data by the witness examination agent. The input data includes audio data, video data, user input data, or case file data. One or more input devices may provide the input data. The input devices may include an audio device, a video device, or a user input device. One or more data stores may further provide the input data. For example, system 200 may include a data store to provide the witness examination agent with case file data.

Based on the processing of the input data, the witness examination agent is configured to generate a prompt or suggestion for the user. The prompt or suggestion may be displayed on a client device to assist the user with the witness examination. The witness examination agent may generate the prompt or suggestion based on processing the input data, such as the audio, video, user input, or case file data. The witness examination agent may use a large language model (also called an LLM) to process the input data to generate the prompt or suggestion. The prompt or suggestion may include any output or modification to user interface elements displayed on a dashboard of a client device to assist a user with a witness examination in real time.

As used herein, the term “witness examination” refers broadly to any setting in which an individual provides statements, testimony, answers to questions, or other forms of examinable information, whether formally or informally, and whether live or simulated. Witness examinations may include, for example, depositions, interviews, informal third-party witness interviews (including those conducted during background investigations or informal discovery by attorneys, law enforcement, or investigators), client preparation sessions, expert-witness drills, sessions conducted with trial consultants or jury consultants, arbitration examinations, cross-examinations or direct examinations in trials or hearings, mediation sessions, administrative hearings, courtroom testimony, mock depositions, mock trials and arbitrations, simulations, attorney training and preparation sessions, witness training sessions, or other similar settings. Witness examinations may further include negotiations, any courtroom or alternative dispute resolution (ADR) proceedings, settlement conferences.

System 200 includes input module 202, examination agent 204 (e.g., witness examination agent), client device 206, and user 208. Input module 202 provides input data to examination agent 204. Examination agent 204 is configured to process the input data and generate a prompt or suggestion for user 208 based on the processing of the input data.

In some embodiments, examination agent 204 may be configured to process the input data during a pre-processing phase and/or a live processing phase. As used herein, the term “pre-processing phase” generally refers to a time period preceding live use of examination agent 204 during a witness examination such as a deposition, training or preparation session, simulation, or other examination or interview setting. For example, the pre-processing phase may be a preparation phase or initial document ingestion phase prior to a live interview setting. As used herein, the term “live processing phase” generally refers to a time period during which examination agent 204 is active and operable to receive and process input data in real time for purposes of assisting a user 208 during a witness examination such as a live deposition, training or preparation session, simulation, or other examination or live interview setting. The prompt or suggestion generated by examination agent 204 may be displayed on a client device 206 to assist user 208 with preparing for or carrying out the witness examination or other interview setting in real-time during the pre-processing phase and/or the live processing phase. System 200 may be executed on any computer system now known or later developed, including, but not limited to, those discussed above with respect to FIG. 1.

In some embodiments, input module 202 includes one or more input devices. The input devices may be one or more audio input devices such as audio input device 210, one or more video input devices such as video input device 212, or one or more user input devices such as user input device 214. Audio input device 210 may be a microphone. In some embodiments, audio input device 210 is a device with a built-in microphone such as a laptop, desktop computer, smartphone, tablet, headset, earpiece, digital voice recorder, or Polycom device. Audio input device 210 may be a high-performance microphone configured to capture improved audio recordings compared to lower-performing microphones often found in commercial-built devices such as laptops or tablets. Audio input device 210 is operable to receive real-time audio data from speaker 216 during a witness examination. For example, audio input device 210 may be a microphone located in a witness examination (e.g., deposition conference room or courtroom) room for capturing audio data (e.g., speech) of speaker 216 during a live witness examination. In another example, audio input device 210 may record audio data of a live witness examination via remote communications. For instance, audio input device 210 may capture audio data of a virtual meeting (e.g., video conference) where speaker 216 is located in a remote location relative to audio input device 210. Further, audio data may be pre-recorded audio files uploaded to a local or remote database accessible by system 200.

In some embodiments, input module 202 may include a plurality of input devices operating simultaneously or sequentially, such as a plurality of audio input devices 210, a plurality of video input devices 212, and/or a plurality of user input devices 214. For example, audio input device 210 may represent a plurality of microphones, multi-microphone arrays, conferencing systems (e.g., Polycom devices), third-party audio capture platforms, or combinations thereof that may be configured to capture audio data from multiple physical or virtual sources. In some embodiments, input module 202 may aggregate audio data received from a plurality of audio input devices 210 during a live witness examination or virtual meeting, such as a video conference in which speaker 216 and/or user 208 communicate from remote locations. In additional embodiments, a plurality of audio input devices 210 may be used during a pre-processing phase to process pre-recorded audio data, upload audio files, or ingest audio from multiple external services or API-based audio repositories prior to the live processing phase.

Speaker 216 is any individual speaking or present during a witness examination or other interview setting. For example, speaker 216 may be any individual giving testimony during a witness examination, such as a witness, deponent, plaintiff, defendant, fact witness, expert witness, organizational representative, non-party witness, custodians of records, or individual identified in discovery. In another example, speaker 216 may be any individual who speaks during a witness examination, such as user 208, counsel for the deponent, court reporter, judge, paralegal, or interpreter. User 208 may be any individual involved in examining an individual during a witness examination. For example, user 208 may be an attorney or any individuals assisting the attorney with the witness examination, such as additional attorneys, paralegals, legal assistants, clients, or consultants (e.g., forensic consultants). In some embodiments, user 208 may be a judge, arbitrator, mediator, juror, court reporter, videographer, judicial officer, party to a case, or any other individual involved in a witness examination.

Video input device 212 may be a video camera, laptop, desktop computer, smartphone, tablet, webcam, or any similar device configured to capture video data. Video input device 212 is operable to receive video data from speaker 216. For example, video input device 212 may be a camera located in a witness examination room (e.g., deposition room) for capturing video data from speaker 216. In another example, video input device 212 may record video data of a live witness examination via remote communications. For instance, video input device 212 may capture video data of a virtual meeting (e.g., video conference) where speaker 216 is located in a remote location (e.g., virtual location) relative to video input device 212.

In some embodiments, system 200 may be a mobile system with a portable recording infrastructure. For example, audio input device 210 and/or video input device 212 may be configured to be easily transported from one witness examination to another witness examination (e.g., a portable recording kit) so that, for example, an attorney can use system 200 in different locations as needed. In other embodiments, system 200 may include stationary, fixed recording infrastructure. For example, audio input device 210 and/or video input device 212 may be fixed within a particular location (e.g., conference room or courtroom) such that system 200 is integrated with the fixed devices for recording audio and/or video data of a deposition or other witness examination proceeding.

User input device 214 may be a keyboard, mouse, laptop, desktop computer, tablet, smartphone, speech-to-text microphone, scanner, or similar device operable to receive user input data. For example, user input device 214 may be configured to allow user 208 to provide different types of data to examination agent 204, such as chat data (e.g., text-based input data) or case file data. Chat data may include data associated with an input, such as chat logs, metadata, contextual data, user profile data, or API call logs. For example, user 208 may be an attorney or a team member of the attorney involved in a witness examination entering one or more inputs into a chat box of a user interface of a laptop. Here, the input is input data provided to a large language model to generate a prompt or suggestion. In some embodiments, the large language model runs on a remote cloud server and is accessed via an API. In other embodiments, the large language model runs locally on a device such as client device 206. For example, the input may be a query entered by user 208 in a chat box displayed on user input device 214, where the query is provided to examination agent 204 for generating a prompt or suggestion to be displayed on client device 206. Client device 206 may be any user input device 214 operable to display the prompt or suggestion to user 208, such as a laptop, desktop computer, tablet, or smartphone.

User input data may further be case file data, such as case file records 218. Case file records 218 may be a collection of legal, factual, or procedural records maintained by attorneys, courts, or parties involved in litigation, investigations, or legal disputes. Case file records 218 may encompass any record relevant to understanding, analyzing, or resolving a case. For example, case file records 218 may include medical records, employment records, contracts and agreements, emails, photographs, police reports, witness statements, financial records, social media posts, text messages and instant messages, incident reports, expert reports, video recording, correspondence letters, business records, insurance policies, accident scene diagrams, audio recordings, court filings, or any other record that may be used in a witness examination proceeding. Further, case file records 218 may include any relevant records related to past witness examinations, such as past witness interviews, depositions, or trials. For example, if user 208 is deposing a forensic expert of a deponent, and the forensic expert testified about something in a different case that is inconsistent with what the forensic expert had said in that other case, case file records 218 may include the documents containing the forensic expert's prior statements. Case file records 218 may further include briefing and/or preparation records. For example, case file records 218 may include any document or record prepared by a law firm of user 208 in preparation for litigation or a witness examination, such as a deposition.

In another example, case file data may include local or remote database records. For example, case file data may include records from a remote database, which are accessed by examination agent 204 via a database API. For instance, examination agent 204 may access case file data via a database API from a legal database (e.g., Lexus, Westlaw, or Bloomberg) located on a local or remote server for accessing various legal records relevant to a witness examination. Case file data may also be pre-loaded (e.g., uploaded) onto a regional and/or remote database of system 200 by user 208. For example, a paralegal may upload case file records 218 onto a user input device 214 before a witness examination, where the pre-loaded case file records are accessible by examination agent 204. In another example, a paralegal may upload case file records 218 before a witness examination via a user input device 214 to a remote database, where the pre-loaded case file records are accessible by examination agent 204 via database APIs.

The user input data, such as the case file and chat data, may be stored in a retrieval-augmented generation (RAG) system and/or a knowledge graph database stored in data store 220. The RAG system and/or knowledge graph database structures and indexes the user input data such that the user input data can be accessed efficiently by an LLM (e.g., examination agent 204) to retrieve relevant information for downstream tasks such as generating a prompt or suggestion based on a query entered by user 208. For example, examination agent 204 may interact with a knowledge graph database to retrieve relevant data for context-aware responses. For instance, user 208 may enter a query into a chat box displayed on user input device 214, such as “What did the witness say about the contract terms?” the RAG system retrieves transcript chunks from the case file data where the term “contract” is mentioned, and the examination agent 204 integrates the retrieved chunks to produce a comprehensive answer (e.g., prompt). Each time case file data is uploaded by user 208, the RAG system may extract the contents of the case file data (e.g., metadata, entities, relationships) and store chunk embeddings using a vector database. Subsequently, when a query is entered by user 208 into a chat box displayed on user input device 214, the query may be converted into a query vector, matched against the stored embeddings of the vector database to retrieve the most similar chunks, and the retrieved chunks may then be provided as input context to examination agent 204 for generating a prompt or suggestion. For example, if a query is entered by user 208, such as “What did the witness say about the incident?” examination agent 204 may retrieve relevant case files related to the incident from the RAG system and/or knowledge graph database for generating a prompt or suggestion. In some embodiments, vector databases may store and retrieve vectors (e.g., high-dimensional vectors) for representing one or more features or attributes of the input data. In some embodiments, the vector databases may be used for machine learning applications such as training of examination agent 204 or natural language processing by examination agent 204.

In some embodiments, input data may be used to train examination agent 204. For example, examination agent 204 may be an LLM trained on the input data provided from input module 202 and/or data store 220. Training of examination agent 204 on the input data may configure examination agent 204. For instance, examination agent 204 may develop domain-specific knowledge by being taught model legal terminology, procedures, and reasoning. For example, examination agent 204 may be trained to understand terms like “summary judgment” or “prima facie case.” Training of examination agent 204 may improve the ability of examination agent 204 to hold legal conversations with context. For example, examination agent 204 may be trained with deposition transcripts to teach conversational patterns and nuances in witness questioning. Training of examination agent 204 may fine-tune processing, adapting examination agent 204 for specific tasks like suggesting witness questions, summarizing cases, or constructing timelines. For example, examination agent 204 may be trained on a dataset of witness examination outlines, such as a deposition outline, to help examination agent 204 suggest questions to user 208 in real-time during a witness examination. Training of examination agent 204 may further enable examination agent 204 to summarize complex legal documents and construct legal arguments. For instance, examination agent 204 may be trained using court opinions to expose examination agent 204 to reasoning frameworks used by judges. Examination agent 204 may further be trained such that examination agent 204 can categorize or extract legal data. For example, examination agent 204 may be trained to label case file sections (e.g., “Factual Background,” “Legal Issues”) to help the model organize content effectively.

In some embodiments, training and configuration of examination agent 204 may include the use of proprietary or curated resources. For example, examination agent 204 may be trained using collections of deposition transcripts, court examination transcripts, arbitration transcripts, hearing transcripts, and other witness examination materials obtained in the pre-processing phase and/or the live processing phase, as well as associated client or case-related data. In some embodiments, examination agent 204 may further be trained or configured using one or more custom prompt libraries or instruction sets developed for witness examinations. Training and configuration of examination agent 204 may further evolve over time based on accumulated usage data or interaction history, enabling refinement of examination-specific behavior and improved performance across witness examination settings.

In some embodiments, audio input device 210 and video input device 212 are integrated within the same device. For example, the input device may be a digital recorder, camera, or webcam configured to capture audio and/or video data simultaneously or selectively. In other embodiments, audio input device 210, video input device 212, and user input device 214 are integrated within the same device. For example, the input device may be a laptop configured to simultaneously or selectively capture audio, video, and user input data. For instance, a laptop may be used to capture audio data of a speaker 216 during a witness examination via a built-in microphone, video data of a speaker 216 during the same witness examination via a built-in camera, and user input data via a keyboard (or similar device) configured for user 208 to provide an LLM input by, for example, typing a query into a chat box of a user interface of the laptop.

System 200 further includes a data store 220 configured to store the input data discussed above, accessible by examination agent 204. For example, data store 220 may store audio, video, user input, and/or case file data. Data store 220 may further store additional input data, such as analysis engine results and dashboard data. Examination agent 204 is configured to access the input data stored in data store 220 in real-time. Data store 220 may be any type of data storage system now known or later developed, including, but not limited to, data store 130 discussed above with respect to FIG. 1. Data store 220 may be a local data store or a remote data store. For example, data store 220 may reside physically on client device 206. For instance, data store 220 may be a database or file system stored on a laptop of user 208. In another example, data store 220 may be hosted remotely on a centralized server or in the cloud, enabling centralized data management and scalability for access by multiple clients over a network. For instance, data store 220 may be a cloud-hosted database or file system accessed via APIs.

It is noted herein that the storage and security measures implemented by system 200 may be configured to comply with one or more industry, legal, governmental, or organizational data security standards, privacy regulations, or professional responsibility requirements. For example, such standards may include, without limitation, SOC 2 Type II, General Data Protection Regulation (GDPR), state privacy acts (e.g., California Consumer Privacy Act (CCPA/CPRA)), Data Processing Agreements (DPA) and Standard Contractual Clauses (SCCs), encryption controls, role-based access control (RBAC), single sign-on (SSO), multi-factor authentication (MFA), audit logging, secure retention controls, Criminal Justice Information Services (CJIS) requirements, ISO 27001, NIST cybersecurity frameworks, NIST AI Risk Management Framework, European Union Artificial Intelligence Act (EU AI Act), International Traffic in Arms Regulations (ITAR), American Bar Association (ABA) Model Rules for Data Security and Confidentiality (e.g., Model Rules 1.6 and 5.3), ISO 27050 (E-Discovery Information Security), NIST 800-53, secure chain-of-custody practices, audit trail requirements, and immutability of legal records.

In some embodiments, system 200 may be deployed in a Federal Risk and Authorization Management Program (FedRAMP)—authorized cloud environment, and/or support compliance with additional applicable global, federal, state, or professional regulatory standards. For example, any cloud-based service provided by or implemented by system 200 to store data may be configured to store the data such that the storage is compliant with FedRAMP.

In some embodiments, the input data is stored in data lakes, such as centralized repositories configured to store structured or unstructured data at any scale. For example, the input data in its native format (e.g., raw data) may be stored in the data lakes until it is needed. Further, the data lakes may be located in cloud-based storage systems or on-premises infrastructure.

In some embodiments, system 200 may be configured to provide hosting infrastructure such that applications and websites may be available and accessible by system 200 over the internet. The hosting may be offered in different forms, such as shared hosting, cloud hosting, virtual private servers (VPS), or dedicated servers.

Input module 202 may include a translation module 222 comprising one or more engines for translating audio or video data into computer-readable data accessible by examination agent 204. Translation module 222 may include a transcription engine 224 configured to transcribe the audio data. For instance, transcription engine 224 may receive the audio data, pre-process the audio data (e.g., filter out background noise or segment audio data into manageable chunks for processing), convert the audio data to text using speech recognition algorithms to produce a textual transcription, perform speaker diarization to separate and label one or more instances of speaker 216, and post-process the textual transcription to refine the transcript's readability and accuracy. Transcription engine 224 may further extract metadata such as timestamps, keywords, and speaker tags. The transcript data generated by transcription engine 224 and the extracted metadata may be stored in data store 220. For example, transcription engine 224 may be used to transcribe speech from speaker 216, such as a witness, into a transcript to generate a live transcript for displaying on client device 206 during a witness examination. Transcription engine 224 may be a local or remote speech-to-text engine (e.g., a third-party service such as Deepgram) accessible via a third-party API. The transcript data may be stored in data store 220 in a line-by-line transcript file (e.g., line-by-line text elements).

Input module 202 may further include a tone and sentiment engine 226 configured to determine tone and sentiment data of speaker 216. The tone and sentiment data may be additional input data accessible by examination agent 204 and stored in data store 220. For example, tone and sentiment engine 226 may be configured to process the audio data and/or the video data from audio input device 210 and video input device 212. Tone and sentiment engine 226 is configured to extract features from the audio data and video data such as acoustic (e.g., frequency, energy levels, or rhythm of speech), linguistic (e.g., words or phrases that express sentiment such as “I feel frustrated”), or visual features (patterns in movement, posture, or facial landmarks such as raised eyebrows). The features extracted by tone and sentiment engine 226 may be further processed through a sentiment and/or tone analysis (e.g., via machine learning or deep learning models) to classify the tone and sentiment of the audio or video data. Once the tone and sentiment data are determined by tone and sentiment engine 226, the tone and sentiment data may be compiled into a structured format for retrieval and analysis by examination agent 204. It is further noted that translation module 222 may also be integrated within examination agent 204. For example, examination agent 204 may include translation module 222, where transcription engine 224 and/or tone and sentiment engine 226 are accessible by examination agent 204 via a third-party API hosted on a remote network.

In some embodiments, system 200 is integrated with third-party collaboration platforms. For example, system 200 may be integrated such that the features and aspects of system 200 generally described in the present disclosure can connect or interact with platforms such as Zoom, Webex, and Microsoft Teams. The integration may further facilitate collaboration and communication between one or more users such as user 208 for carrying out a witness examination via system 200, allowing the use of various features such as video conferencing, chat, and event scheduling as provided by these integrated platforms.

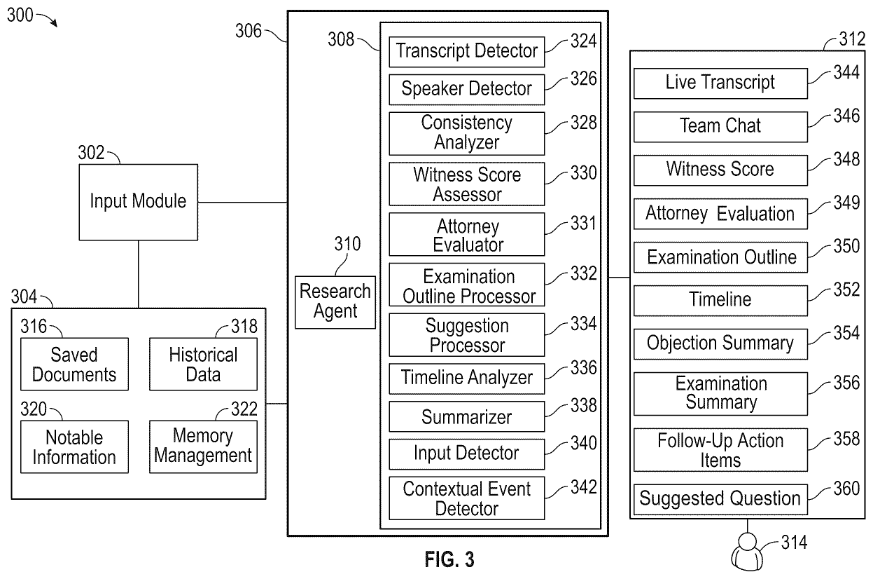

Examination agent 204 may include an analysis engine 228 and a research agent 230 for generating a prompt (e.g., response or output) to a query entered by user 208 in a chat box displayed on user input device 214. The prompt may be displayed on client device 206. Examination agent 204 may use machine learning techniques and models (e.g., supervised, unsupervised, or reinforcement learning) to generate a response to user 208 based on the query and the input data provided by input module 202 or stored in data store 220. In some embodiments, examination agent 204 may be an LLM that utilizes neural networks to decipher the meaning behind human-understandable language. In some embodiments, examination agent 204 may be trained on the input data discussed above. In other embodiments, examination agent 204 may be further trained on historical data, such as historical data 318 discussed below in FIG. 3. Analysis engine 228 and research agent 230 are further discussed below with respect to analysis engine 308 and research agent 310 depicted in FIG. 3.

FIG. 3 depicts an exemplary witness examination assistant system for assisting a user with a witness examination in accordance with embodiments of the invention generally referred to as system 300. Broadly, system 300 includes all features and aspects of system 200 depicted in FIG. 2. For example, system 300 may include input module 302, data store 304, examination agent 306, analysis engine 308, research agent 310, examination dashboard 312, and user 314, all of which generally relate to similar features and aspects of system 200. Examination agent 306 may process input data provided by input module 302 or data store 304 for generating a prompt or suggestion. The prompt may include any output or modification to user interface elements displayed on an examination dashboard 312 of a client device for assisting user 314 with a witness examination in real-time.

Data store 304 may include additional data other than the input data referenced in FIG. 2 above, such as saved documents 316, historical data 318, and notable information 320. In some embodiments, saved documents 316 include any case file data uploaded to data store 304 by user 314. In some embodiments, historical data 318 includes capturing and organizing snapshots or logs of examination dashboard 312 at different points in time. In other embodiments, historical data includes past processing data and prompts generated by analysis engine 308.

In some embodiments, notable information 320 includes key insights, highlights, or extracted data from the input data that may be relevant to the witness examination at hand. For example, notable information 320 may include parties involved (e.g., names of plaintiffs, defendants, witnesses, or experts), associated roles (e.g., lead counsel, presiding judge), organizations (e.g., corporate entities, governmental agencies, or law firms mentioned), contact information (e.g., key individuals'contact details), important dates (e.g., the time or day a particular event occurred), core claims or defenses (e.g., main allegations, counterclaims, or defenses presented by the parties), precedents cited (e.g., legal cases or statutes frequently referenced), relationships (e.g., data showing connections such as a witness linked to multiple parties), cross-references (e.g., notable ties between case file documents such as how evidence A supports testimony B), inconsistencies (e.g., conflicting testimony or errors in documentation), or historical trends (e.g., details from related cases or prior dealings between parties). Additionally, data store 304 may include a memory management system 322 configured to manage how the data in data store 304 is stored, accessed, and managed in memory and other storage layers.

Examination agent 306 is configured to operate on (e.g., process) the input data provided by input module 302 and/or stored in data store 304. Further, as discussed above, examination agent 306 may be an LLM trained on the input data provided from input module 302 and/or data store 304. In some embodiments, examination agent 306 may behave as a conversational bot. For example, user 314 may input an input, such as a query, into a chat box displayed on a user input device, and examination agent 306 may generate a prompt or suggestion based on the query and present the prompt or suggestion back to user 314 in a human-readable format through examination dashboard 312.

In some embodiments, the input may be user input. For example, user 314 may be an attorney or a team member of an attorney entering one or more queries into a chat box of a user interface (e.g., examination dashboard 312) displayed on a laptop. In another example, user 314 may be an individual involved in any type of interview or examination setting, such as a judge involved in a courtroom proceeding, where the judge enters a query into the chat box. For instance, user 314 may enter the query “generate an outline for this deposition,” and examination agent 306 may process the input data and generate a prompt that modifies a deposition outline displayed to user 314 via examination dashboard 312. In some embodiments, the input may be predetermined (e.g., preconfigured by a user or automatic). For example, examination agent 306 may automatically generate a prompt based on one or more predetermined inputs. For instance, the predetermined input may be a keyword such as “November,” where examination agent 306 automatically updates a timeline displayed on examination dashboard 312 upon processing the audio data and detecting the word “November.”

In some embodiments, examination agent 306 includes analysis engine 308 and research agent 310. In some embodiments, upon receiving the input, analysis engine 308 generates a prompt based on the input data. Analysis engine 308 may implement one or more task modules to generate prompts or suggestions. The task modules, as described below, may be implemented automatically, without user input, based on a predetermined LLM input. In other embodiments, the task modules may be implemented based on user input, such as a query entered into a chat box displayed on examination dashboard 312 or user 314 selecting a user interface element displayed on examination dashboard 312 configured to implement a task module upon selection.

Different types of task modules may be implemented by analysis engine 308 to generate a prompt or suggestion. For example, the task modules may be a transcript detector 324, speaker detector 326, consistency analyzer 328, witness score assessor 330, attorney evaluator 331, examination outline processor 332, suggestion processor 334, timeline analyzer 336, summarizer 338, input detector 340, or contextual event detector 342.

The prompt or suggestion generated by analysis engine 308 may be an update or a modification to one or more interface elements displayed on examination dashboard 312. For example, interface elements that may be modified or updated by the generated prompt include a live transcript 344, a team chat 346, a witness score 348, an attorney evaluation 349 (e.g., an attorney performance evaluation), an examination outline 350 (e.g., deposition outline), a timeline 352, an objection summary 354, an examination summary 356, follow-up action items 358, or a suggested question 360.

In some embodiments, analysis engine 308 may be configured to implement the task modules during the pre-processing phase prior to the live processing phase. For example, the input data received by input module 302 during the pre-processing phase may include the audio data, video data, user input data, and case file discussed herein in reference to FIG. 2. The input data received during the pre-processing phase may further include saved documents 316, historical data 318, and notable information 320. In such embodiments, analysis engine 308 and associated task modules may process the input data to extract contextual metadata, identify key entities, generate preliminary summaries, and automatically associate tags, labels, or classifications with the input data prior to the processing of a live witness examination or other interview setting. The automatically generated tagging or labeling during this pre-processing phase may include issue-specific labels, witness names, asserted claims, referenced facts, dates, events, or other notable information. In some embodiments, these preprocessed preliminary summaries, metadata, tagging, or classifications may be stored within data store 304 for later retrieval and use during the live processing phase.

In some embodiments, analysis engine 308 may be configured to implement the task modules after the pre-processing phase and during the live processing phase. For example, the task modules may be implemented during a live witness examination or other live interview setting such that real-time input data received by input module 302 is processed. For example, transcript detector 324 may dynamically update a live transcript generated from live audio data in real time, speaker detector 326 may identify a current speaker in real time, consistency analyzer 328 may evaluate live witness testimony for inconsistency relative to previously stored information, witness score assessor 330 and attorney evaluator 331 may assess behavioral indicators in real time, examination outline processor 332 may identify outline topics relevant to live testimony, suggestion processor 334 may surface documents that are relevant to the line of questioning in real time, timeline analyzer 336 may populate or adjust a live contextual timeline, summarizer 338 may generate summaries in real time, input detector 340 may detect newly received input such as uploaded documents or chat queries in real time, and contextual event detector 342 may identify live contextual triggers associated with current testimony. The real-time operations of these task modules may supplement, update, or further populate data store 304 with newly processed information, including additional metadata, auto-generated tagging, extracted entities, contextual summaries, or other notable information associated with documents, transcripts, or other input data received in real time.

In some embodiments, such input data collected or generated by the task modules during the live processing phase may be combined with input data identified during the pre-processing phase such that the pre-processed information may be used to respond to input data received at input module 302 during the live processing phase. For example, transcripts, documents, or other input data received at input module 302 in real time during a live witness examination, including documents newly produced by a deponent or other witness, may be processed through the task modules and automatically tagged, summarized, or otherwise classified using the same tagging logic, metadata extraction, or classification processing implemented during the pre-processing phase. Accordingly, task modules may operate continuously across both the pre-processing phase and the live processing phase such that data store 304 maintains a unified and evolving repository of tagged documents, witness examination transcripts, contextual information, metadata, timeline data, and other information described herein. For instance, pre-processing operations may inform, enhance, or modify real-time tagging, classification, summarization, or other processing of input data received during a live witness examination or other live interview setting. The implementation of each task module by analysis engine 308 during the pre-processing phase and the live processing phase is further discussed below.

In some embodiments, analysis engine 308 implements the task modules using one or more instances of research agent 310. Research agent 310 is configured to fetch information for implementing the task modules of analysis engine 308. Research agent 310 may fetch the information from data store 304 and/or input module 302. In some embodiments, research agent 310 fetches information via third-party APIs on a remote network during the live processing phase. For example, research agent 310 may use an API to fetch information from large databases containing case file data during a live witness examination or other live interview setting. The information fetched by research agent 310 may be used to provide the relevant data required for analysis engine 308 to implement the task modules described above during the live processing phase.

In some embodiments, research agent 310 may further use such third-party APIs during the pre-processing phase to ingest documents, retrieve relevant case materials, obtain metadata, or automatically collect information prior to a live witness examination or other live interview setting. For example, research agent 310 may call third-party APIs to automatically ingest input data such as case file data, pleadings, discovery documents, or prior witness examination transcripts into data store 304 as part of an initial document ingestion phase, and subsequently initiate metadata extraction, summarization, or document relevance scoring based on the retrieved third-party data.

In some embodiments, examination agent 306 may dynamically select one or more instances of research agent 310 in real time during the pre-processing phase or the live processing phase to help process one or more task modules such that computational resources are conserved. For example, examination agent 306 may implement a research agent 310 (e.g., or a plurality of instances of research agent 310) when processing the transcript detector 324 while implementing a different instance of research agent 310 when processing the speaker detector 326. Dynamically implementing one or more instances of research agent 310 to assist in processing different task modules at the same time advantageously allows system 300 to improve the functionality of system 300 by reducing the amount of computation resources required for generating one or more prompts or suggestions. For example, analysis engine 308 may activate or deactivate research agent 310 based on the type of task module being processed, such that the computational resources required for system 300 depend only on the task modules being processed at any given time. Further, a user may manually activate or deactivate the task modules via a settings option displayed on examination dashboard 312. In some embodiments, the one or more instances of research agent 310 may be organized such that there is a research agent 310 acting as director and a plurality of sub-agents. For example, the research agent 310 acting as director may dynamically select the one or more sub-agents to help process the one or more task modules.

In some embodiments, examination agent 306 may use different context window sizes (e.g., short, medium, or long) for implementing any one of the task modules to manage the trade-off between computational resources used by system 300 and the quality of the prompt or suggestion generated. For example, examination agent 306 may be configured to dynamically change the context window size based on the complexity of a task or the type of task module being implemented. In another example, the context window sizes used for implementing different task modules may be predetermined or user-set.

In some embodiments, analysis engine 308 implements transcript detector 324 to generate a prompt for modifying, in real-time, live transcript 344 during a witness examination. For example, live transcript 344 may be modified based on transcript detector 324 processing transcript data retrieved by research agent 310 from data store 304. For example, a speaker (generally related to speaker 216 referenced in FIG. 2 above) may be a witness (e.g., deponent) speaking during a deposition. The input module 302 may generate transcript data of the witness'words using a transcription engine, where the transcript data is stored in data store 304. Upon research agent 310 retrieving the transcript data, transcript detector 324 may process the transcript data and generate a prompt to display live transcript 344 to user 314 via examination dashboard 312.

In some embodiments, transcript detector 324 may be implemented during the pre-processing phase. For example, transcript detector 324 may process previously stored transcript data retrieved by research agent 310 from data store 304 to pre-populate, annotate, or refine transcript information before the live processing phase. In such embodiments, pre-processed transcript information may be used to support later real-time transcript modification and display of live transcript 344 during a live witness examination or other live interview setting.

In some embodiments, analysis engine 308 implements speaker detector 326 via research agent 310 to generate a prompt for modifying, in real-time, examination dashboard 312. Speaker detector 326 may generate a prompt or suggestion based on the input data. For example, speaker detector 326 may process the audio and/or video data to generate a prompt to update examination dashboard 312. For instance, upon research agent 310 retrieving audio data, speaker detector 326 may process the audio data to distinguish between speakers (e.g., diarization) of a witness examination. Speaker detector 326 may further process the transcript data and/or the tone and sentiment data determined by the translation module, as discussed in FIG. 2 above, to distinguish between speakers (e.g., detect one or more particular speakers).

Upon processing the data, speaker detector 326 may generate a prompt for updating user interface elements of examination dashboard 312. The prompt may include an update in real-time to live transcript 344 with the names of each speaker as they are detected by speaker detector 326. For example, a speaker may introduce themselves during a witness examination by saying, “My name is John,” and speaker detector 326 may process the audio data to assign the speaker to “John” or “Speaker 1” and update live transcript 344 such that any subsequent remarks by John will be labeled as “John” or “Speaker 1” (or any other user-set label) within live transcript 344. Further, speaker detector 326 may process the video data, in addition to the audio data, to improve the accuracy of assigning speakers. For example, input data, such as the determined tone and sentiment data, may be used to match the audio data with the assigned speaker. For instance, speaker detector 326 may match audio-based identification features (e.g., rhythm of speech) with video-based features (e.g., lip movement) to confirm speaker identity. Analyzing both audio data and video data can help distinguish between speakers when, for example, the audio input device receives overlapping audio data of multiple speakers.

In some embodiments, speaker detector 326 may be implemented during the pre-processing phase. For example, speaker detector 326 may process previously stored audio data, video data, transcript data, tone and sentiment data, and other input data retrieved by research agent 310 from data store 304 to pre-identify, annotate, or classify speakers prior to a live witness examination or other interview setting. In such embodiments, speaker identities or preliminary diarization information generated during the pre-processing phase may be used to support later real-time speaker assignment, speaker labeling, and dashboard updates during a live witness examination or other live interview setting.

In some embodiments, analysis engine 308 implements consistency analyzer 328 to generate a prompt for modifying, in real-time, examination dashboard 312. Consistency analyzer 328 may generate a prompt based on the input data. For example, consistency analyzer 328 may process the transcript data and case file data to reveal an inconsistency between the real-time testimony of a witness and the case file data. Consistency analyzer 328 may generate a suggestion to alert user 314 to the inconsistency.

For instance, research agent 310 may retrieve past, pre-processed transcript data given by a speaker, such as a witness, from the case file data to determine if there is an inconsistency between the real-time transcript data of the witness and the past transcript data of the witness. Upon determining an inconsistency, speaker detector 326 may generate a prompt or suggestion to alert user 314 of the inconsistency. For example, speaker detector 326 may alert user 314 by flagging (e.g., highlighting, underlining, or bolding) the inconsistent statement displayed by live transcript 344. In another example, speaker detector 326 may generate a prompt or suggestion to display a message in team chat 346, such as “John has made an inconsistent statement based on previous testimony.” The prompt or suggestion may further provide user 314 access to the previous inconsistent statement via a message in team chat 346, such as a link to a document stored in data store 304. In another example, the prompt or suggestion may provide a message to team chat 346 advising user 314 to further address the revealed inconsistency by suggesting a question for user 314 to ask the witness regarding the inconsistency. In other examples, the prompt may update examination outline 350 to include a question (e.g., clarification question) to ask the witness regarding the inconsistent statement, update follow-up action items 358 by providing a note to user 314 to review the inconsistency at a later time, or update suggested question 360 with a suggested question to ask user 314 based on the revealed inconsistency.

In some embodiments, consistency analyzer 328 may be implemented during the pre-processing phase. For example, consistency analyzer 328 may process previously stored transcript data, case file data, deposition outlines, or other input data retrieved by research agent 310 from data store 304 to identify potential inconsistencies prior to the live processing phase. In such embodiments, pre-identified inconsistencies, contextual indicators, or preliminary consistency results generated during the pre-processing phase may be used to support or enhance later real-time inconsistency detection, prompting, or suggestion generation during a live witness examination or other live interview setting.

In some embodiments, analysis engine 308 implements witness score assessor 330 to generate a prompt for modifying, in real-time, examination dashboard 312. Witness score assessor 330 may generate a prompt or suggestion based on the input data. For example, witness score assessor 330 may process the transcript data and case file data to update a witness score 348. Witness score 348 may be a quantifiable score assigned to a witness based on different factors such as the witness'reliability, or truthfulness. For example, witness score assessor 330 may implement research agent 310 to retrieve past inconsistency data from historical data 318, and based on processing the past inconsistency data, witness score assessor 330 may generate a prompt to update witness score 348. For instance, the greater the number of times that consistency analyzer 328 has generated a prompt to flag an inconsistent witness statement, the lower the witness score 348 may be. In another example, witness score assessor 330 may generate a prompt or suggestion based on the tone and sentiment data generated by the tone and sentiment engine. For example, witness score assessor 330 may implement research agent 310 to retrieve tone and sentiment data from data store 304, and based on processing the tone and sentiment data, witness score assessor 330 may generate a prompt to update witness score 348. For example, upon determining that the witness is uncomfortable or nervous based on the tone and sentiment data, witness score assessor 330 may update witness score 348 by decreasing the witness score.

In some embodiments, witness score assessor 330 may be configured to perform an evaluation of a witness'performance during an examination setting and generate one or more outputs based on that evaluation. Such outputs may include, for example, witness score 348, categorical indicators, visual representations, annotations, alerts, summaries, or other evaluative information relating to the witness'performance. Accordingly, witness score 348 may represent one example output generated by witness score assessor 330 and may reflect all or a portion of the broader witness evaluation, which may also include additional qualitative or contextual outputs displayed via deposition dashboard 312.

In some embodiments, witness score assessor 330 may be implemented during the pre-processing phase. For example, witness score assessor 330 may process previously stored transcript data, historical data 318, notable information 320, tone and sentiment data, and other input data retrieved by research agent 310 from data store 304 to pre-compute or update witness score 348 prior to the live processing phase. In such embodiments, pre-computed witness score information may be used to support or enhance later real-time witness scoring, prompting, or suggestion generation during a live witness examination or other live interview setting.

In some embodiments, analysis engine 308 implements attorney evaluator 331 to generate a prompt for modifying, in real time, examination dashboard 312. Attorney evaluator 331 may generate a prompt or suggestion based on the input data. For example, attorney evaluator 331 may process the transcript data, case file data, objection history, consistency determinations, suggested question usage, or outcome of prior questioning to update attorney evaluation 349. In some embodiments, attorney evaluation 349 may represent an assessment or evaluation of the performance of a user 208, such as a deposing attorney or other user 208 conducting a witness examination during the pre-processing phase or the live processing phase. Attorney evaluator 331 is not limited to use during live depositions and may additionally be implemented during other witness examination proceedings, such as training sessions, preparation sessions, simulations, or mock witness examinations, to evaluate and provide feedback on the performance of a user 208 outside of a live deposition.

Attorney evaluation 349 may include one or more outputs, such as a numerical score, categorical ratings, visual indicators, annotations, alerts, summaries, or qualitative feedback. For example, attorney evaluation 349 may be based on one or more performance factors of user 208, including effectiveness of questioning, ability to overcome objections or instructions not to answer, adherence to an examination outline, utilization of suggested questions, strategic sequencing of topics, or other performance-related metrics. In some embodiments, attorney evaluation 349 may be a quantifiable score assigned to a user 208 conducting a witness examination.

In some embodiments, attorney evaluator 331 may implement research agent 310 to retrieve historical questioning data, objection histories, prior transcripts processed during a pre-processing phase, and other input data retrieved from data store 304. Based on processing such information, attorney evaluator 331 may generate a prompt to increase, decrease, or otherwise update attorney evaluation 349, such as a numerical score, in real time. For instance, attorney evaluator 331 may decrease a numerical score or provide an updated summary of an attorney evaluation 349 based on identifying missed opportunities, improper phrasing, repeated lines of questioning, or unaddressed objections. In another example, attorney evaluator 331 may increase a numerical score or provide an updated summary of an attorney evaluation 349 based on determining that the attorney successfully elicited key testimony, effectively responded to a witness answer, or appropriately followed a recommended line of questioning from an examination outline.

In some embodiments, attorney evaluator 331 may be implemented during a pre-processing phase. For example, attorney evaluator 331 may process previously stored transcripts, historical data 318, notable information 320, and other input data retrieved from data store 304 to pre-compute or partially compute an attorney evaluation 349, such as a numerical score or summary based on past evaluation performance of a user 208, prior to a live witness examination or interview setting. In such embodiments, pre-computed attorney evaluation information may be used to support or enhance later real-time attorney evaluation, scoring, prompting, or suggestion generation during a live witness examination or other live interview setting.

In some embodiments, analysis engine 308 implements examination outline processor 332 to generate a prompt for modifying, in real-time, examination dashboard 312. Examination outline processor 332 may generate a prompt based on the input data. For example, examination outline processor 332 may process the transcript data and case file data to update an examination outline 350, such as a deposition outline. For example, examination outline processor 332 may implement research agent 310 to retrieve past, pre-processed witness examination transcripts from the case file data, such as transcripts of past witness examinations taken by the opposing counsel relating to the same case, and generate an examination outline 350 to assist the deposing attorney with witness preparation. Examination agent 306 may be used before, during, or after a live witness examination. For instance, examination outline processor 332 may generate an examination outline 350 during the pre-processing phase prior to a witness being examined by opposing counsel, such that the attorney can prepare the witness for the witness examination based on prior witness examination strategies used by the opposing counsel. In some embodiments, examination outline processor 332 may generate a pre-examination first-line outline such that an examination outline 350 is generated for providing an attorney with a starting point, or an initial draft, for preparing for an upcoming witness examination. The initial draft may include information such as case information, witness information, key topics, preliminary questions, and objectives.

In some embodiments, examination outline processor 332 is used as a first-pass outline preparation assistant. For example, the case file data may include an attorney's initial draft of an examination outline, such as a deposition outline. Upon implementation, examination outline processor 332 may generate a prompt or suggestion, such as displaying an updated examination outline based on the case file data already accessible by examination agent 306. For instance, examination outline processor 332 may update the initial draft to include additional questions based on two contradicting statements the deponent made to police on the night the deponent witnessed an event relevant to the case at hand. The contradicting statements may be located in a witness statement taken by police and stored in data store 304 of system 300.

Examination outline processor 332 may further be implemented by analysis engine 308 based on user input. For example, examination outline processor 332 may be implemented upon user 314 entering a query into team chat 346, such as “generate a deposition outline” or “update current deposition outline for witness John Doe in Smith v. Jones, case number 123_A to add questions related to the witness'visibility of the car incident referenced in the police report taken on Nov. 11, 2021.” Further, examination outline processor 332 may be implemented upon user 314 selecting a selectable user interface element displayed via examination dashboard 312, such as a “generate deposition outline” element or “update a current deposition outline” element.

In some embodiments, examination outline processor 332 may further monitor input data in real time during a live witness examination or other interview setting to determine whether a particular question included in a generated examination outline 350 has already been asked or answered. For example, examination outline processor 332 may process live transcript data to automatically identify that a question included in the examination outline 350 has been addressed by a witness and mark such question as completed, crossed off, or otherwise visually distinguished within the examination outline 350. In some embodiments, examination outline processor 332 may compare live testimony to corresponding outline topics and dynamically update the status of outline items, thereby assisting a user in keeping track of coverage of the examination outline 350 in real time.

As discussed, examination outline processor 332 may be implemented during the pre-processing phase. For example, examination outline processor 332 may process case file data, saved documents 316, historical data 318, notable information 320, prior witness examination transcripts, and other input data retrieved by research agent 310 from data store 304 to pre-generate, pre-populate, or refine examination outline 350 prior to the live processing phase. In such embodiments, pre-processed outline information may be used to support or enhance later real-time examination outline updating, prompting, or suggestion generation during a live witness examination or other interview setting.

In some embodiments, analysis engine 308 implements suggestion processor 334 to generate a prompt for modifying, in real-time, examination dashboard 312. Suggestion processor 334 may generate a prompt or suggestion based on the input data. For example, suggestion processor 334 may process the input data to update team chat 346. For instance, suggestion processor 334 may generate a prompt or suggestion to display a message in team chat 346 that makes a suggestion to user 314. The suggestion may be any question or statement to assist user 314 in examining a witness. For example, user 314 may be an attorney defending a deponent during a deposition. Suggestion processor 334 may generate a prompt or suggestion via team chat 346, alerting the attorney to make an objection. For example, based on the transcript data, suggestion processor 334 may update team chat 346 by displaying a message that states, “object to this statement” or “make a leading objection to this statement.” In other examples, suggestion processor 334 may update team chat 346 to provide messages suggesting “gotcha questions” to ask a witness based on the processing of the input data.

Further, suggestion processor 334 may be implemented by examination agent 306 based on user input. For example, examination dashboard 312 may contain a selectable user interface element configured to implement suggestion processor 334 upon selection by user 314. For example, examination dashboard 312 may include a user interface element, “suggest a question,” where the suggestion processor 334 may update suggested question 360 with a suggested question upon user selection.

In some embodiments, suggestion processor 334 may be implemented during the pre-processing phase. For example, suggestion processor 334 may process transcript data, case file data, saved documents 316, historical data 318, notable information 320, and other input data retrieved by research agent 310 from data store 304 to pre-identify issues, prepare suggested questions, or pre-generate suggestion content prior to the live processing phase. In such embodiments, pre-processed suggestion information may be used to support or enhance later real-time suggestion generation, prompting, objection recommendations, or question suggestions during a live witness examination or other live interview setting.

In some embodiments, analysis engine 308 implements timeline analyzer 336 to generate a prompt for modifying, in real-time, examination dashboard 312. Timeline analyzer 336 may generate a prompt based on the input data. For example, timeline analyzer 336 may process the input data to update timeline 352. Timeline 352 may be a dynamic, chronological timeline for organizing various events mentioned in a witness examination. For instance, timeline analyzer 336 may process transcript data retrieved by research agent 310. Upon detecting a time or date, timeline analyzer 336 may generate a prompt to update timeline 352 accordingly, based on the time or date detected. For example, upon a witness stating that “On Monday, Nov. 22, 2024, at 8 pm, I went to the grocery store, and at 8:30 pm, somebody walked in with a knife,” timeline analyzer 336 generates a prompt to update timeline 352 to organize the witness' statement in chronological order for reference by user 314.

In some embodiments, timeline analyzer 336 may be implemented during the pre-processing phase. For example, timeline analyzer 336 may process transcript data, case file data, saved documents 316, historical data 318, notable information 320, and other input data retrieved by research agent 310 from data store 304 to pre-generate, pre-populate, or refine timeline 352 prior to a live witness examination or other live interview setting. In such embodiments, the resulting pre-processed timeline may be made available to a user 314 (e.g., a deposing attorney) for review prior to the witness examination, including during an initial document ingestion and preparation phase.

In some embodiments, during the live processing phase, timeline analyzer 336 may build or update a real-time timeline based on live testimony received from a witness and dynamically compare the evolving real-time timeline to the pre-processed timeline. Accordingly, timeline analyzer 336 may identify differences, discrepancies, or conflicts between pre-processed timeline data and live processing data. Timeline analyzer 336 may generate prompts or suggestions responsive to such conflicts, including suggested questions to ask the witness or deponent regarding the discrepancy, recommended follow-up inquiries, or indicators presented via examination dashboard 312 calling out conflicting chronological information provided by user 314.

In some embodiments, analysis engine 308 implements summarizer 338 to generate a prompt for modifying, in real-time, examination dashboard 312. Summarizer 338 may generate a prompt based on the input data. For example, summarizer 338 may process the input data to update objection summary 354 or examination summary 356. Objection summary 354 and examination summary 356 may be user interface elements displayed on examination dashboard 312 for providing a summary (e.g., list) of the objections made in a witness examination or a general summary of the witness examination at a given point in time. For example, objection summary 354 may aggregate and organize the number of times each type of objection (such as an objection to form) has been made during a deposition. In some embodiments, summarizer 338 generates a prompt to update live transcript 344 to display a bookmark reference for each objection made in the witness examination or displayed by objection summary 354. Summarizer 338 may be implemented by analysis engine 308 based on user input. For example, examination dashboard 312 may contain a selectable user interface element configured to implement summarizer 338 upon selection by user 314. For example, examination dashboard 312 may include a user interface element, “summarize,” where the summarizer 338 may update objection summary 354 or examination summary 356 upon user selection.

In some embodiments, summarizer 338 may be implemented during the pre-processing phase. For example, summarizer 338 may process transcript data, case file data, saved documents 316, historical data 318, notable information 320, and other input data retrieved by research agent 310 from data store 304 to pre-generate, pre-populate, or refine objection summary 354 or examination summary 356 prior to the live processing phase. In such embodiments, pre-generated summaries may be used to support or enhance later real-time summary generation, objection aggregation, bookmark generation, or dashboard updating during a live witness examination or other live interview setting.

In some embodiments, analysis engine 308 implements input detector 340 to implement one or more task modules. Input detector 340 may process user input data and implement one or more task modules based on the user input data. For example, user 314 may enter a query into team chat 346, such as “suggest a question” or “suggest final round follow-up questions.” Upon processing the chat data, input detector 340 may prompt examination agent 306 to implement suggestion processor 334 for updating suggested question 360 with a question. Input detector 340 allows user 314 to call examination agent 306 on demand based on user-input data, such as a query entered into team chat 346, to prompt examination agent 306 to implement one or more task modules. Further, input detector 340 may implement one or more task modules before, during, or after a witness examination.

Additionally, input detector 340 may implement one or more task modules based on user input from user 314 at any location. For example, input detector 340 may process user input from a forensic expert, a client, a consultant, an associate attorney, or a paralegal who enters a query into team chat 346 from their respective client device. Thus, any number of users, such as user 314, may provide input data to examination agent 306 to update examination dashboard 312 and/or access the examination dashboard 312 to assist in the examination of a witness.

In some embodiments, input detector 340 may be implemented during the pre-processing phase. For example, input detector 340 may process user input data, chat queries, or other input data retrieved by research agent 310 from data store 304 to pre-select, pre-configure, or pre-invoke one or more task modules prior to the live processing phase.

In some embodiments, analysis engine 308 implements contextual event detector 342 to generate a prompt for modifying, in real-time, examination dashboard 312. Contextual event detector 342 may generate a prompt or suggestion based on the input data. For example, upon detecting a contextual event based on the processing of the input data, contextual event detector 342 may generate a prompt to update examination dashboard 312. A contextual event may include the detection of one or more alerts, such as a user-set or default alert. For example, one or more alerts may be a noteworthy moment. For instance, case file data stored in data store 304 may contain a document assigned by user 314 or examination agent 306 as a “ critical” piece of evidence. Upon a witness mentioning the document during a witness examination, contextual event detector 342 may generate a prompt or suggestion to update team chat 346 such that user 314 is notified that the witness has just mentioned the critical document.

Further, upon notification, contextual event detector 342 may generate a prompt or suggestion that provides user 314 access to the document via team chat 346. In another example, a noteworthy moment may be a witness mentioning a document stored in data store 304 or generally accessible by examination agent 306. Upon the witness mentioning the document, contextual event detector 342 may generate a prompt or suggestion to update team chat 346 such that user 314 is notified that the document can be referenced via team chat 346. In another example, a noteworthy moment may include a witness referring to another person or an organization. Upon the witness mentioning another person or an organization, contextual event detector 342 may process the input data to gather information on the person or organization and generate a prompt or suggestion to display the gathered information to user 314 via team chat 346.

In some embodiments, contextual event detector 342 may implement a “people searcher” function to automatically collect, retrieve, or aggregate information relating to a detected individual or entity. For example, upon detecting a predetermined name, noun, identified person, or other entity from transcript data or other input data, contextual event detector 342 may query external data sources such as internet search engines, public databases, people-search platforms, social media services (e.g., LinkedIn), or background-information services to obtain additional contextual information associated with the predetermined individual or entity. In some embodiments, contextual event detector 342 may generate a prompt or suggestion including a link, reference, or direct navigational element to externally retrieved information (e.g., a profile page, biography, website listing, or background check result), and display such prompt or suggestion via team chat 346 or other user interface elements of examination dashboard 312 during a live witness examination or other interview setting.

In some embodiments, contextual event detector 342 may also perform internal people searching using case file data, saved documents 316, historical data 318, notable information 320, and other input data previously ingested during a pre-processing phase. For example, contextual event detector 342 may analyze previously stored emails, message logs, documents, witness transcripts, entity references, or communication records to determine whether the person or entity mentioned during the live processing phase is referenced elsewhere in the pre-processed data maintained in data store 304. In some embodiments, contextual event detector 342 may generate a prompt or suggestion identifying relevant preprocessed input data associated with the person or entity, and provide direct access (e.g., a selectable link) to such data, thereby allowing user 314 to navigate to such pre-processed content relating to the identified individual or entity in real time.

In some embodiments, an alert may include detecting an evasive answer. For example, contextual event detector 342 may process the tone and sentiment data of a witness, and upon determining that the witness'audio and/or video data indicates an evasive characteristic (e.g., unreliable, untrustworthy, or nervous), contextual event detector 342 may update team chat 346 to suggest a question to user 314 such that an evasive answer can be more likely detected.

In some embodiments, an alert may include detecting a follow-up action item. For example, based on the processing of the input data, contextual event detector 342 may update follow-up action items 358 with one or more suggestions for user 314 to take during or after the witness examination is over. For example, contextual event detector 342 may generate a prompt or suggestion to update follow-up action items 358 with items for user 314 to review. For example, follow-up action items 358 may include next steps to take, items that should be reported to clients, draft messages for sending to clients, supplemental requests to make to opposing counsel, or supplemental requests made by opposing counsel that need to be responded to. In some embodiments, follow-up action items 358 may further include suggested additional deposition notices of newly identified witnesses, notices of additional written discovery requested or implied by live testimony, or suggested supplemental discovery responses to send to opposing counsel. In some embodiments, such follow-up action items 358 may further include recommended post-examination investigative steps, issuance of subpoenas, scheduling of additional witness examinations, or other actions relevant to continuing litigation or other interview setting. In some embodiments, contextual event detector 342 may generate the prompt or suggestion to update follow-up action items 358 in response to processing the output of summarizer 338. For example, summarizer 338 may generate an examination summary identifying new witnesses, additional issues, or unanswered questions, and contextual event detector 342 may process such summary output to detect one or more follow-up action items 358 and automatically update follow-up action items 358 accordingly.

In some embodiments, an alert may include the detection of classified information. For example, contextual event detector 342 may process the input data, such as the transcript data, and upon determining that a privileged document (e.g., a document designated as “attorneys'eyes only” or a protective order document) has been mentioned by a speaker, contextual event detector 342 may generate a prompt or suggestion to alert user 314. For example, contextual event detector 342 may update live transcript 344 by flagging or highlighting the relevant transcript text to indicate that the transcript lines mention a classified document or include classified information contained in the classified document. In another example, contextual event detector 342 may update team chat 346 to display a message to user 314 indicating that a classified document has just been mentioned or provide user 314 with access to the classified document via a selectable link.

In some embodiments, contextual event detector 342 may generate a prompt to activate or deactivate examination agent 306 based on detecting one or more alerts. For example, contextual event detector 342 may activate examination agent 306 (e.g., begin recording the audio data and/or video data) upon detecting certain words received by an audio input device or particular objects being detected by a video input device. For instance, examination agent 306 may not be activated until the audio input device detects the words “on the record” or a similar user-set parameter. In another example, examination agent 306 may not be activated until the video input device detects at least one individual, such as a witness, in the camera frame of a video input device. In some embodiments, examination agent 306 may be deactivated (e.g., stop recording the audio data and/or video data) upon the audio input device detecting the words “off the record,” “break,” or a similar user-set parameter. In other embodiments, examination agent 306 may be deactivated upon detecting that no individuals are within the camera's frame or if there has been silence for a predetermined amount of time (e.g., more than 15 seconds).

Other alerts may include the detection of a contradiction, user 314 requesting a document, a witness referencing a law, a witness referencing the name of a new witness, when user 314 has not pressed the witness enough with a certain line of questioning, or when a user 314 has pressed the witness too much with a certain line of questioning.

In some embodiments, contextual event detector 342 may be implemented during the pre-processing phase. For example, contextual event detector 342 may process transcript data, case file data, saved documents 316, historical data 318, notable information 320, user-defined alerts, and other input data retrieved by research agent 310 from data store 304 to pre-identify alert conditions, pre-associate contextual events with specific documents, or pre-classify certain data, such as previous witness statements, as noteworthy prior to the live processing phase. In such embodiments, pre-processed alert conditions or contextual associations may be used to support or enhance real-time alert detection and real-time prompting based on live input data received by input module 302 during a live witness examination or other live interview setting.

For example, a document may be pre-classified during the preparation phase as a “critical” exhibit, and contextual event detector 342 may subsequently detect live testimony that references that exhibit and generate a prompt or suggestion during the live witness examination to notify user 314. In another example, a particular witness's prior testimony may have been marked during pre-processing as inconsistent or previously evasive, and contextual event detector 342 may detect live testimony exhibiting similar patterns and prompt user 314 to ask a clarifying question, flag the testimony for follow-up action items 358, or access the previously identified document or transcript stored in data store 304. In another example, contextual event detector 342 may suggest potential exhibits for use during a witness examination. For example, contextual event detector 342 may identify documents that could be used to authenticate a document for evidentiary purposes and generate prompts or suggestions recommending such documents to user 314 prior to or during a deposition proceeding.

In some embodiments, system 300 includes additional task modules implemented by examination agent 306 for generating prompts or suggestions based on the processing of the input data. For example, additional task modules may include a witness preparer, objections aggregator, magic soundbite processor, issue tracker, objections prompter, outline progress tracker, final questions processor, document extractor, LLM input customizer, or LLM input tuner. The prompts or suggestions generated by the additional task modules may be displayed within examination dashboard 312.

In some embodiments, analysis engine 308 implements the witness preparer such that prompts or suggestions are generated to prepare a witness for an upcoming witness examination. In some embodiments, analysis engine 308 implements the objections aggregator such that prompts or suggestions are generated to alert user 314 to any objections made during a witness examination. In some embodiments, analysis engine 308 implements the magic soundbite processor such that prompts or suggestions are generated for displaying highlight reels of testimony given in the witness examination based on predetermined criteria (e.g., speaker, topic, or keywords). In some embodiments, analysis engine 308 implements the issue tracker such that prompts are generated for alerting user 314 to different categories of issues that were addressed during the witness examination. For example, the issue tracker may generate a prompt for displaying a post-examination memorandum that correlates witness testimony received during the witness examination with different issues or topics such as legal theories, causes of action, or elements (e.g., elements of a legal cause of action) relevant to the legal case at hand.

In some embodiments, analysis engine 308 implements the objections prompter such that prompts or suggestions are generated for alerting user 314 (e.g., an attorney defending a deposition) to objections that should be made during the witness examination. In some embodiments, analysis engine 308 implements the outline progress tracker such that prompts or suggestions are generated for alerting user 314 to how much progress has been made in addressing items in an examination outline being used during the witness examination. In some embodiments, analysis engine 308 implements the final questions processor such that prompts or suggestions are generated for alerting user 314 to final questions to ask the witness before ending the witness examination. In some embodiments, analysis engine 308 implements the document extractor such that prompts are generated for providing user 314 with access to documents (e.g., case file documents) that may be helpful in assisting a user 314 in the witness examination based on the processing of the input data. In some embodiments, analysis engine 308 implements the LLM input customizer such that LLM inputs provided to examination agent 306 may be automatically modified or tailored to generate specific prompts or suggestions for user 314. In some embodiments, analysis engine 308 implements the LLM input tuner so that examination agent 306 is fine-tuned (e.g., trained) based on the LLM inputs being provided to examination agent 306. For example, the LLM input tuner may automatically train examination agent 306 on additional datasets based on past LLM inputs and past prompts or suggestions generated by examination agent 306 such that the performance of examination agent 306 with handling particular tasks or subject matter is improved over time.

In some embodiments, system 300 may include additional hardware components for activation or deactivation of system 300. For example, system 300 may include an electronics kit that may be communicatively coupled (e.g., USB, Wi-Fi, or Bluetooth) to a client device of user 314. For instance, user 314 may be an attorney preparing to take a witness examination. The attorney and the witness may be physically located in the same room or different rooms (e.g., a remote meeting via video call). In some embodiments, the electronics kit is configured to trigger the attorney's client device (e.g., laptop) to activate or deactivate examination agent 306 based on the state or orientation of the electronics kit. For example, the electronics kit may include sensors (e.g., accelerometer) to detect the physical orientation of the kit. System 300 may be activated or deactivated upon a predetermined orientation of the electronics kit. For example, upon orienting the electronic kit in an open or closed configuration, system 300 may be activated or deactivated such that an audio input device and/or a video input device of system 300 begins recording or stops recording data of a witness examination. For instance, the electronic kit may include a camera that is operable to receive audio and video data. Upon orienting the camera in an open configuration (e.g., upright), examination agent 306 may begin receiving the audio data and/or video data of a witness. Further, upon deviating from the upright position (e.g., putting the camera in a face-down position), the camera may be in a closed configuration, and system 300 is deactivated such that system 300 stops recording the audio data and/or video data of a witness.

In some embodiments, system 300 may be activated or deactivated upon determining that a predetermined number of individuals (e.g., quorum) are located or oriented in a certain way within the frame of a camera (e.g., presence sensing). In another example, system 300 may be activated or deactivated upon determining that an individual involved in the witness examination has spoken a predetermined phrase (e.g., verbal context detection). For example, system 300 may stop recording audio data if the opposing counsel states, “Let's take a five-minute break” or a similar phrase indicating that privileged information (e.g., attorney-client privilege) may subsequently be introduced based on the predetermined phrase. In even a further example, system 300 may alert a user or speaker when system 300 is “on the record,” or recording audio and video data, based on an indicator light (e.g., recording indicator) being displayed by the electronics kit. In some embodiments, the electronics kit includes the audio input device 210 and/or the video input device 212 described above in FIG. 2. In some embodiments, system 300 may be activated or deactivated responsive to a user input. For example, upon a user 314 selecting a selectable user interface element displayed within examination dashboard 312, system 300 may start or stop recording input data.

As discussed, system 200 and system 300, described above in FIGS. 2-3, are not limited in their application to deposition proceedings. Examination agent 306 may advantageously provide a real-time, documented transcript of the dialogue being spoken in any witness examination or other interview setting, along with any of the additional features disclosed in system 200 and system 300 above.

In some embodiments, system 300 may be used in a courtroom proceeding (or other witness examination) to provide various functions typically performed by a court reporter or interpreter. For example, courts are currently experiencing a shortage in court reporters and interpreters, where these positions are not being filled. System 300 may help solve or mitigate this problem by acting as a real-time transcript generator and providing additional functions typically performed by a court reporter or interpreter. For instance, examination agent 306 may be further configured to act as an interpreter for parties to a proceeding by translating transcribed audio data to a desired language such that a real-time transcript is accessible to the parties in a language they can understand.

System 200 and system 300 may further be used as a training simulator. For example, examination agent 306 may be used to simulate a real-time witness examination such that a user 314 (or any individual) may practice conducting different types of proceedings, such as a deposition proceeding. For instance, an attorney may practice taking a witness examination using system 300, where real-life conditions of witness examinations may be simulated by system 300. For instance, system 300 may be configured to use artificial input data (e.g., using input data from a made-up case or a past case) for simulating a witness examination proceeding, where the artificial input data is accessible by examination agent 306 for generating prompts or suggestions, as described above, for user 314. In general, any of the features and aspects of system 200 or system 300 disclosed above may be leveraged to be used in a courtroom proceeding or as a training simulator.

In some embodiments, examination agent 306 may further be used to evaluate the performance of an attorney or other user 314 in mock witness examinations, such as mock depositions, mock cross examinations, mock arbitrations, mock hearings, or other simulated interview settings. For example, during a mock session, attorney evaluator 331 may generate performance feedback relating to questioning effectiveness, utilization of suggested questions, response to objections, and overall examination strategy. In some embodiments, examination agent 306 may provide real-time performance evaluation, post-session reports, or other training outputs. In some embodiments, the same performance evaluation or training outputs may be used in preparation for a witness examination, or any other scenario in which user 314 seeks to practice and refine questioning effectiveness outside of a live witness examination.

In some embodiments, de-identified documents, transcript data, prior witness examination materials, or other case file information may be used during training simulations, mock witness examination, and other simulated interview settings. For example, examination agent 306 may import firm documents or transcripts in a de-identified form and use such de-identified input data for training and simulation purposes. For instance, identifiable information such as names, firm names, organizations, personal identifiers, or case-specific details may be removed, masked, or replaced prior to the live processing phase of the training setting or other simulated interview settings.

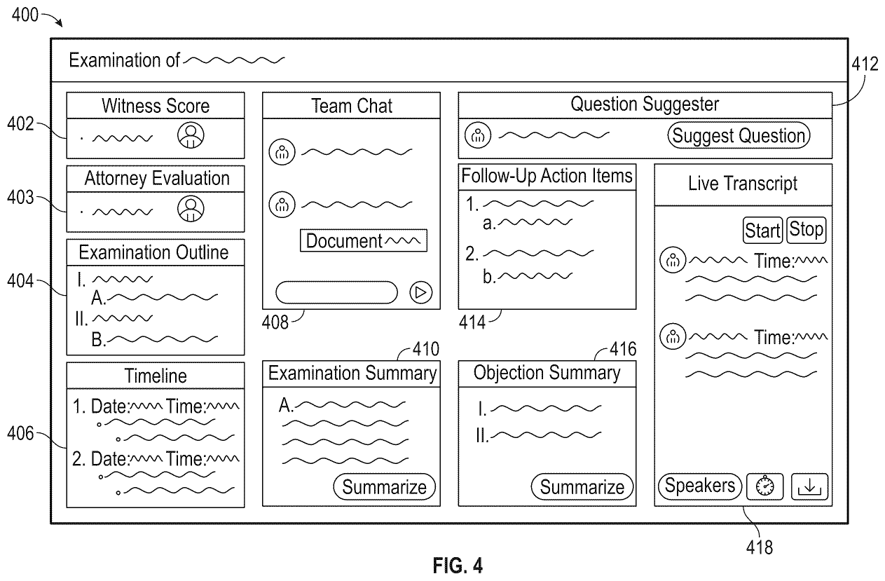

FIG. 4 depicts an exemplary user interface of an examination dashboard 312 (e.g., witness examination dashboard) referenced above in FIG. 3. User interface may include one or more user interface elements such as witness score 402, attorney evaluation 403, examination outline 404, timeline 406, team chat 408, examination summary 410, question suggester 412, follow-up action items 414, objection summary 416, and live transcript 418. The user interface elements are generally related to one or more interface elements displayed on examination dashboard 312, as described in FIG. 3 above. The user interface elements may be modified or updated based on the prompt generated by an examination agent (such as examination agent 306 described above in FIG. 3). User interface 400 may be displayed on a user's client device during a witness examination or other interview-like setting. In some embodiments, user interface 400 may be displayed on more than one client device at the same time. For example, a plurality of individuals, such as an attorney and a paralegal, may simultaneously access user interface 400 via a network. User interface 400 may be dynamically updated in real-time during a witness examination based on one or more prompts or suggestions generated by the examination agent.

In some embodiments, user interface 400 includes witness score 402. Witness score 402 may provide a clear and intuitive visual representation of a witness's reliability in real time. For example, witness score 402 may feature a range-like display, such as a bar, gauge, or number that spans from 0 to 100. As witness score assessor 330 (referenced above in FIG. 3) evaluates various factors (such as consistency, coherence, tone, sentiment, and corroboration of the witness's statements), witness score 402 may update dynamically to reflect the current score of the witness. In another example, the bar or gauge may be color-coded, such as transitioning from red at the lower end (indicating low reliability, closer to a score of 0) to green at the higher end (indicating high reliability, approaching a score of 100). Additionally, numeric values may be displayed alongside the gauge, allowing users to ascertain the exact score quickly. Witness score 402 may further include supplementary text providing insights into what specific aspects influenced the score change of a witness, enhancing a user's understanding of the witness's credibility. In some embodiments, witness score 402 may include a plurality of outputs representing an evaluation of the witness, such as numerical scores, visual indicators, annotations, alerts, summaries, or other qualitative or contextual information relating to the witness's performance or credibility.

In some embodiments, user interface 400 further includes attorney evaluation 403. Attorney evaluation 403 may provide a clear and intuitive visual representation of the performance of an attorney, examining attorney, or any user 314 conducting a witness examination in real time. For example, attorney evaluation 403 may be a numerical score featuring a range-like display, such as a bar, gauge, or number that spans from 0 to 100. As attorney evaluator 331 (referenced above in FIG. 3) evaluates various performance factors, attorney evaluation 403 may update dynamically to reflect one or more performance outputs of user 314, such as the numerical score or an ongoing evaluation summary. In another example, the bar or gauge representing the numerical score may be color-coded, such as transitioning from red at the lower end to green at the higher end. Additionally, numeric values may be displayed alongside the gauge, allowing user 314 to ascertain the exact numerical score quickly. Attorney evaluation 403 may further include supplementary text providing insights into what specific aspects influenced a numerical score change or evaluation summary change, thereby enhancing a user's understanding of their examination performance in real time.

In some embodiments, user interface 400 includes examination outline 404. Examination outline 404 may streamline a witness examination, providing users with a structured and interactive framework that updates dynamically during the witness examination. For example, examination outline 404 may feature a collapsible and expandable outline structure that organizes questions into categories (e.g., background information, specific events, expert opinions) and subcategories for easy navigation. As the witness examination unfolds, examination outline processor 332 (referenced above in FIG. 3) may process input data in real-time and generate a prompt or suggestion to automatically suggest relevant questions that pertain to the topics being discussed. For instance, if a deponent during a deposition begins talking about a specific incident, related questions to the specific incident may be dynamically displayed via examination outline 404, allowing the user to quickly pivot to areas of interest without losing track of the conversation. Examination outline 404 may include visual cues, such as checkmarks or color changes, to indicate which questions have been asked and answered, helping users track progress throughout the witness examination. For example, in response to examination outline processor 332 processing input data, examination outline 404 may visually reflect asked and answered questions in real time, such as by showing crossed-out questions, checkmarks, shading, or other progress indicators associated with an item (e.g., question or suggestion) contained within the examination outline 404, dynamically updating the examination outline as input data is received in real time.

Additionally, the examination outline 404 may display follow-up questions or prompts based on responses from the witness. Users may add personal notes or annotations next to specific questions, which may be stored in a data store and retrieved for later analysis. To further facilitate ease of use, examination outline 404 may include a search function that allows users to locate specific terms or topics within examination outline 404 quickly. Examination outline 404 serves as a dynamic and responsive tool, improving efficiency and organization during witness examination while ensuring comprehensive coverage of all relevant topics.

In some embodiments, user interface 400 includes timeline 406. Timeline 406 may represent the chronology of events discussed during a witness examination, providing users with an intuitive way to follow the progression of testimony over time. For example, timeline 406 may feature a horizontal or vertical timeline that automatically updates in real-time as the witness provides input concerning dates, times, and relevant events. For example, as the witness examination progresses, timeline analyzer 336 (referenced above in FIG. 3) may process a witness'spoken data, extracting key temporal information for constructing event markers on timeline 406. An event marker may be represented by a visual icon or labeled point that indicates when specific events occurred. For instance, if the witness mentions a critical date or incident, timeline 406 may dynamically add a corresponding marker, complete with details such as a brief description and any associated visuals (like images or documents) referenced. To enhance usability, users may hover over or click on timeline markers to reveal additional context, such as deponent testimony or related events. Timeline 406 may also incorporate color-coded sections to differentiate between various types of events (e.g., incidents, testimonies, or document submissions), allowing users to discern patterns and relationships quickly. In some embodiments, users may manually adjust or add annotations to timeline 406, enabling users to highlight areas of interest or add notes that correspond to specific markers. Timeline 406 allows users, such as legal professionals or investigators, to organize their analysis effectively and visualize the flow of information during witness examinations.

In some embodiments, user interface 400 includes team chat 408. Team chat 408 may display real-time user collaboration during a witness examination, incorporating dynamic updates based on various inputs. Team chat 408 may include a chat box where one or more team members assisting with a witness examination may input queries, comments, or observations related to the witness examination. Each message may be timestamped and attributed to the respective user. As users engage in the chat, prompts or suggestions generated by examination agents (such as examination agent 306 referenced above in FIG. 3) may be displayed in team chat 408 via an autonomous speaker label, such as “Examination Assistant,” “Examination Agent,” or “AI Assistant.” For example, an examination agent may process user queries in combination with other user input, such as audio data, video data, and case file data, to display relevant messages in team chat 408. For example, when a deposing attorney asks a question about case law or procedural guidelines during a deposition, the examination agent may automatically generate a prompt or suggestion to be displayed in team chat 408, such as providing the user with immediate access to the relevant case law or procedural guideline via a selectable link.

Additionally, team chat 408 may include a selectable examination agent button allowing users to summon the examination agent on demand. For example, the examination agent button may prompt the examination agent to deliver specific resources, answer legal inquiries, or provide context-sensitive assistance based on the ongoing conversation. In some embodiments, team chat 408 includes threaded replies, enabling users to engage in focused discussions without cluttering the main chat flow. In some embodiments, team chat 408 includes a search functionality to locate past discussions or contributions from the examination agent quickly. Team chat 408 promotes efficient collaboration and information sharing, ensuring all team members remain aligned and informed throughout a witness examination.

In some embodiments, team chat 408, or user interface 400 in general, may include a real-time exhibit portal configured to selectively present documents to a witness or other participant of a witness examination during the live processing phase. For example, examination agent 306 may enable user 314 to upload, select, or reveal one or more potential exhibits from a set of pre-loaded documents, and selectively present a chosen exhibit to the witness in real time. For example, the selected exhibit may be transmitted or made accessible through a user interface element such as team chat 408, where a selectable link or preview may be displayed to a witness or participant for viewing. In such embodiments, the witness may access and review the exhibit, scroll through pages, or otherwise examine the electronic document in a manner analogous to reviewing a physical exhibit. The real-time exhibit portal may further support remote participation, enabling electronic sharing, marking, and controlled disclosure of exhibits during remote or virtual witness examinations.

In some embodiments, user interface 400 includes examination summary 410. Examination summary 410 may display real-time insights into ongoing witness examination based on the processing of input data by summarizer 338 (as referenced above in FIG. 3). Examination summary 410 may be organized into clearly defined segments, such as key topics, critical events, and significant quotes, allowing users to grasp essential details of a witness examination quickly. Examination summary 410 may include visual elements, such as color coding or icons, to enhance readability by highlighting various types of content, such as agreements or disputes. Users may also add annotations or personal notes to specific summary points displayed by examination summary 410 to facilitate personalized analysis and follow-up.

In some embodiments, user interface 400 includes question suggester 412. Question suggester 412 may assist a user by dynamically displaying question prompts or suggestions during a witness examination. Question suggester 412 may display questions to a user based on a prompt from suggestion processor 334 (as referenced above in FIG. 3) that continuously analyzes real-time input data, including the witness'responses and the context of the witness examination. As the witness examination unfolds, question suggester 412 may display a curated list of suggested questions relevant to the current dialogue of the witness examination. In some embodiments, question suggester 412 may display the questions in a prioritized manner, such as highlighting the most critical questions. In some embodiments, each suggested question may be expanded to show more context or rationale, providing insight into why asking at that specific time might be beneficial. Users may also modify or customize the suggested questions to better align with a user's examination strategy. Question suggester 412 enhances a user's ability to conduct thorough, strategic inquiries, ensuring critical areas are explored while adapting to the ever-evolving nature of the witness examination.

In some embodiments, user interface 400 includes follow-up action items 414. Follow-up action items 414 may dynamically update, in real-time, based on the processing of input data by one or more task modules (as discussed above in FIG. 3). As the witness examination progresses, follow-up action items 414 may display a comprehensive list of actionable items tailored to the context of the witness examination. The action items may be displayed in a clear, organized format, prioritizing tasks based on urgency and relevance, ensuring that users can quickly identify what requires immediate attention. In some embodiments, each action item may be accompanied by contextual details, such as related quotes or issues from the witness examination, allowing users to quickly understand the rationale behind each listed item. Users may also customize follow-up action items 414 by adding notes, setting deadlines, or assigning tasks to team members for improved collaboration and accountability. Additionally, follow-up action items 414 may include visual indicators, such as checkboxes or progress bars, to help track the completion status of each item. By providing a dynamic and interactive framework for managing follow-up actions, follow-up action items 414 assists users in maintaining organization and focus during a witness examination, ensuring that critical matters are addressed in a timely manner.

In some embodiments, user interface 400 includes objection summary 416. Objection summary 416 may provide users with a real-time overview of all objections raised during a witness examination based on the processing of input data by summarizer 338 (as referenced above in FIG. 3). For example, as each objection is made in a deposition, objection summary 416 may dynamically update to reflect the nature, context, and rationale behind the objection, presenting the information in a clear and accessible format. In some embodiments, each item displayed by objection summary 416 may be organized by the type of objection and the number of instances an objection was made (such as relevance, hearsay, or leading question), helping attorneys quickly identify patterns or recurring challenges. In some embodiments, each objection entry may be clicked to view more detailed notes, including the timestamp of the objection, related statements, and responses from both the witness and opposing counsel. Objection summary 416 allows attorneys to manage objections effectively, maintain control over the examination process, and enable efficiencies in the discovery motion process.

In some embodiments, user interface 400 includes live transcript 418. Live transcript 418 may display real-time documentation of the dialogue of a witness examination. For example, live transcript 418 may update based on the processing of real-time audio data via transcript detector 324 (as referenced above in FIG. 3), displaying an accurate transcription of spoken dialogue in real-time. In some embodiments, live transcript 418 may include selectable buttons that allow users to start or stop the audio recording, ensuring that the users have control over what gets captured during the witness examination and what audio data is being recorded. In some embodiments, live transcript 418 includes a selectable download button for a user to save the live transcript for later access or sharing, making it convenient for users to organize their documentation and collaborate with colleagues. In some embodiments, live transcript 418 may include a timer that indicates the duration of the witness examination, helping users keep track of the time elapsed and manage the session effectively.

In some embodiments, user interface 400 may be accessed or modified by a user via an augmented reality (AR) apparatus. For example, the user may view and interact with the user interface elements of user interface 400 by integrating the augmented reality apparatus with the user interface 400. For instance, the user may use hand movements, eye gestures (e.g., blinking or focusing), voice commands, or touch-free control via one or more sensors of the AR apparatus to interact with the user interface elements of user interface 400. An AR apparatus may take the form of an AR headset, glasses, or contact lenses and may include earpieces.

In some embodiments, system 200 and system 300 may be configured to automatically display relevant documents, citations, excerpts, or other information determined by examination agent 306 as being contextually significant. For example, and as discussed above, contextual event detector 342 may generate a prompt or suggestion including a link, reference, or direct navigational element to contextually relevant documents in real time based on input data and display such prompt or suggestion via team chat 346 or other user interface elements of examination dashboard 312 during a live witness examination or other interview setting. In some embodiments, examination agent 306 may implement multiple layers of AI intelligence during the live processing phase such that the task modules identify numerous potentially relevant items, while additional prioritization logic selectively filters or surfaces only higher-value or more contextually important items for presentation to user 314, thereby reducing noise in the user interface 400.

For example, rather than presenting a full document in response to an identified reference in the transcript data, user interface 400 may automatically present a specific portion of the relevant document, scroll to a relevant page or paragraph, and/or highlight cited language determined to be pertinent to a question being asked, testimony being given, or a contextual event detected by contextual event detector 342. In other embodiments, user interface 400 may provide optional expansion or preview controls such that user 314 may review surrounding document content while still preserving a streamlined focus on the most relevant portions surfaced in real time.

In some embodiments, system 200 and system 300 may be configured to integrate with third-party invoicing or legal practice management platforms to facilitate billing, expense reimbursement, and/or time tracking associated with witness examination preparation, witness examination sessions, or other interview settings. For example, the systems disclosed herein may export time entries, witness examination duration information, or usage-based service metadata to external billing platforms, such as Clio or other legal management systems, thereby enabling automatic generation of invoices, reimbursement requests, or client billing entries related to witness examination or interview activity, such as deposition activity. In certain embodiments, such billing or invoicing information may be generated during or after the live processing phase and may include information relating to witness examination scheduling, preparation time, transcript review time, or other witness examination-related legal services.

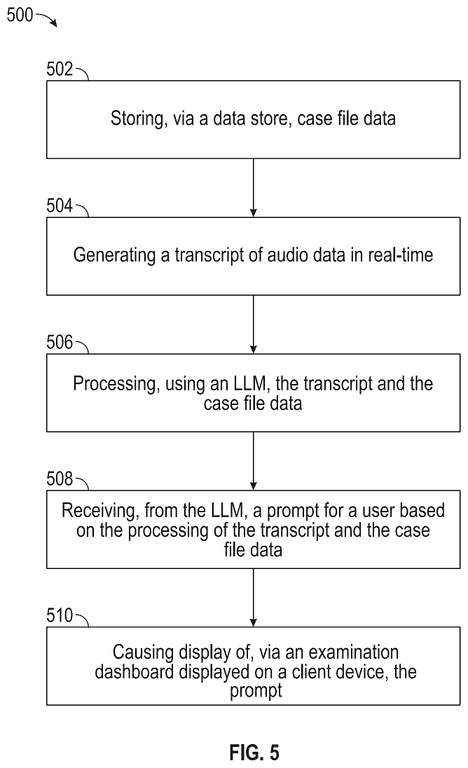

FIG. 5 depicts an exemplary method for assisting with a witness examination proceeding or other interview setting, generally referred to as method 500. Method 500 may be carried out in whole or in part by any system or systems, including system 200 and system 300 described above. At step 502, case file data is stored via a data store. As described above with respect to data store 220 and case file records 218 of FIG. 2, the case file data may be a collection of legal, factual, or procedural records maintained by attorneys, courts, or parties involved in witness examinations, such as litigation activity, investigations, or legal disputes.

At step 504, a transcript of audio data is generated in real-time. For example, a transcript based on audio data received by a microphone during a witness examination or other interview setting may be generated. The transcript may be stored in the data store.

At step 506, the transcript and the case file data are processed using an LLM. As described above in FIG. 3, the LLM may be trained on input data such as the case file data.

At step 508, a prompt or suggestion for a user is received from the LLM based on the processing of the transcript and the case file data. As discussed above in FIG. 3, the prompt or suggestion may include any output or modification to user interface elements displayed on an examination dashboard of a client device for assisting a user with a witness examination or other interview setting in real-time.

At step 510, the prompt or suggestion is displayed on a client device via an examination dashboard. As described above in FIG. 2, the client device may be any device operable to display the prompt or suggestion to a user, such as a laptop, desktop computer, tablet, or smartphone.

The following embodiments represent exemplary embodiments of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting.

Clause 1. A witness examination assistant system, comprising: one or more microphones operable to receive audio data of a witness; one or more cameras operable to receive video data of the witness; a user input device operable to receive user input data comprising chat data; a data store for storing case file data; at least one processor; and one or more non-transitory computer-readable media comprising computer-executable instructions that, when executed by the at least one processor, perform a method for assisting with a witness examination proceeding, the method comprising: storing, via the data store, the case file data; providing, to a large language model and in real time during the witness examination proceeding, the audio data and the case file data; receiving, from the large language model and in response, a suggestion for a user; and causing display of, to the user and via a witness examination dashboard displayed on a user device, the suggestion for the user.

Clause 2. The witness examination assistant system of clause 1, wherein the method further comprises determining tone and sentiment data based at least on the video data or the audio data.

Clause 3. The witness examination assistant system of any of clauses 1-2, wherein the suggestion is further based on the tone and sentiment data.

Clause 4. The witness examination assistant system of any of clauses 1-3, wherein the case file data includes a deposition outline, wherein the suggestion includes modifying in real time the deposition outline.

Clause 5. The witness examination assistant system of any of clauses 1-4, wherein processing of the audio data and the case file data by the large language model reveals an inconsistency between testimony of the witness and the case file data, wherein the suggestion includes a question to ask the witness regarding the inconsistency.

Clause 6. The witness examination assistant system of any of clauses 1-5, wherein the chat data is provided as an input to the large language model, wherein the suggestion is further based on the chat data.

Clause 7. The witness examination assistant system of any of clauses 1-6, wherein the suggestion includes updating a timeline displayed on the witness examination dashboard.

Clause 8. The witness examination assistant system of any of clauses 1-7, wherein the large language model runs on a remote cloud server.

Clause 9. The witness examination assistant system of any of clauses 1-8, wherein the large language model is trained at least on the case file data.

Clause 10. The witness examination assistant system of any of clauses 1-9, wherein the audio data is provided to the large language model as a real-time transcript.

Clause 11. The witness examination assistant system of any of clauses 1-10 ,wherein processing of the audio data and the case file data by the large language model detects an instance of a particular speaker, wherein the suggestion is further based on the instance of the particular speaker.

Clause 12. A method for assisting with a witness examination proceeding, the method comprising: storing, via a data store, case file data; receiving, via one or more microphones, audio data of a witness; providing, to a large language model and in real time during the witness examination proceeding, the audio data and the case file data; receiving, from the large language model and in response, a suggestion for a user; and causing display of, to the user and via a witness examination dashboard displayed on a user device, the suggestion for the user.

Clause 13. The method of clause 12, further comprising: receiving, via a user input device, chat data; and providing, to the large language model and in real time during the witness examination proceeding, the chat data, wherein the suggestion is based at least in part on the chat data.

Clause 14. The method of any of clauses 12-13, further comprising; generating an attorney evaluation based on a performance of the user during the witness examination proceeding; and causing display of, to the user and via the witness examination dashboard, the attorney evaluation.

Clause 15. The method of any of clauses 12-14, further comprising: generating a witness score based on a reliability of the witness during the witness examination proceeding; and causing display of, to the user and via the witness examination dashboard, the witness score.

Clause 16. One or more non-transitory computer-readable media storing computer-executable instructions that, when executed by at least one processor, perform a method for assisting with a witness examination proceeding, the method comprising: storing, via a data store, case file data; providing, to a large language model and in real time during the witness examination proceeding, audio data of a witness, chat data, and the case file data; receiving, from the large language model and in response, a suggestion for a user; and causing display of, to the user and via a witness examination dashboard displayed on a user device, the suggestion for the user.

Clause 17. The one or more non-transitory computer-readable media of clause 16, wherein providing the audio data to the large language model comprises providing a real-time transcript generated from the audio data.

Clause 18. The one or more non-transitory computer-readable media of any of clauses 16-17, further comprising; generating a witness examination outline based on the case file data; and causing display of, to the user and via the witness examination dashboard, the witness examination outline.

Clause 19. The one or more non-transitory computer-readable media of any of clauses 16-18, wherein the suggestion includes updating, based on the real-time transcript, the witness examination outline displayed on the witness examination dashboard, wherein updating the witness examination outline comprises: updating a progress indicator associated with an item contained within the witness examination outline.

Clause 20. The one or more non-transitory computer-readable media of any of clauses 16-19, further comprising: detecting, within the real-time transcript, a predetermined name; and retrieving, upon detecting the predetermined name, contextual information associated with the predetermined name via one or more external data sources, wherein the suggestion is based at least in part on the contextual information.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A witness examination assistant system, comprising:
one or more microphones operable to receive audio data of a witness;
one or more cameras operable to receive video data of the witness;
a user input device operable to receive user input data comprising chat data;
a data store for storing case file data;
at least one processor; and
one or more non-transitory computer-readable media comprising computer-executable instructions that, when executed by the at least one processor, perform a method for assisting with a witness examination proceeding, the method comprising:
storing, via the data store, the case file data;
providing, to a large language model and in real time during the witness examination proceeding, the audio data and the case file data;
receiving, from the large language model and in response, a suggestion for a user; and
causing display of, to the user and via a witness examination dashboard displayed on a user device, the suggestion for the user.

2. The witness examination assistant system of claim 1, wherein the method further comprises determining tone and sentiment data based at least on the video data or the audio data.

3. The witness examination assistant system of claim 2, wherein the suggestion is further based on the tone and sentiment data.

4. The witness examination assistant system of claim 1, wherein the case file data includes a deposition outline, wherein the suggestion includes modifying in real time the deposition outline.

5. The witness examination assistant system of claim 1,
wherein processing of the audio data and the case file data by the large language model reveals an inconsistency between testimony of the witness and the case file data,
wherein the suggestion includes a question to ask the witness regarding the inconsistency.

6. The witness examination assistant system of claim 1,
wherein the chat data is provided as an input to the large language model,
wherein the suggestion is further based on the chat data.

7. The witness examination assistant system of claim 1, wherein the suggestion includes updating a timeline displayed on the witness examination dashboard.

8. The witness examination assistant system of claim 1, wherein the large language model runs on a remote cloud server.

9. The witness examination assistant system of claim 1, wherein the large language model is trained at least on the case file data.

10. The witness examination assistant system of claim 1, wherein the audio data is provided to the large language model as a real-time transcript.

11. The witness examination assistant system of claim 1,
wherein processing of the audio data and the case file data by the large language model detects an instance of a particular speaker,
wherein the suggestion is further based on the instance of the particular speaker.

12. A method for assisting with a witness examination proceeding, the method comprising:
storing, via a data store, case file data;
receiving, via one or more microphones, audio data of a witness;
providing, to a large language model and in real time during the witness examination proceeding, the audio data and the case file data;
receiving, from the large language model and in response, a suggestion for a user; and
causing display of, to the user and via a witness examination dashboard displayed on a user device, the suggestion for the user.

13. The method of claim 12, further comprising:
receiving, via a user input device, chat data; and
providing, to the large language model and in real time during the witness examination proceeding, the chat data, wherein the suggestion is based at least in part on the chat data.

14. The method of claim 12, further comprising;
generating an attorney evaluation based on a performance of the user during the witness examination proceeding; and
causing display of, to the user and via the witness examination dashboard, the attorney evaluation.

15. The method of claim 12, further comprising:
generating a witness score based on a reliability of the witness during the witness examination proceeding; and
causing display of, to the user and via the witness examination dashboard, the witness score.

16. One or more non-transitory computer-readable media storing computer-executable instructions that, when executed by at least one processor, perform a method for assisting with a witness examination proceeding, the method comprising:
storing, via a data store, case file data;
providing, to a large language model and in real time during the witness examination proceeding, audio data of a witness, chat data, and the case file data;
receiving, from the large language model and in response, a suggestion for a user; and
causing display of, to the user and via a witness examination dashboard displayed on a user device, the suggestion for the user.

17. The one or more non-transitory computer-readable media of claim 16, wherein providing the audio data to the large language model comprises providing a real-time transcript generated from the audio data.

18. The one or more non-transitory computer-readable media of claim 17, further comprising;
generating a witness examination outline based on the case file data; and
causing display of, to the user and via the witness examination dashboard, the witness examination outline.

19. The one or more non-transitory computer-readable media of claim 18, wherein the suggestion includes updating, based on the real-time transcript, the witness examination outline displayed on the witness examination dashboard, wherein updating the witness examination outline comprises:
updating a progress indicator associated with an item contained within the witness examination outline.

20. The one or more non-transitory computer-readable media of claim 17, further comprising:
detecting, within the real-time transcript, a predetermined name; and
retrieving, upon detecting the predetermined name, contextual information associated with the predetermined name via one or more external data sources,
wherein the suggestion is based at least in part on the contextual information.
